(19) United States
(12) Patent Application Publication
(10) Pub. No.: US 2007/0192186 A1
(43) Pub. Date: Aug. 16, 2007

(54) Search, transfer, and booking tool for multiple rewards programs

(75) Inventors: Nancy E. Greene, New York, NY (US); Harvey Katz, Greensboro, NC (US); David Kroner, Woodcliff Lake, NJ (US); Chris J. Munkacsy, Hamilton Square, NJ (US); Marniee L. Nottingham, London (GB); Matthew S. Rogers, New York, NY (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Co., Inc. a New York Corporation

(21) Appl. No.: 11/404,080

(22) Filed: Apr. 14, 2006

Related U.S. Application Data
(60) Provisional application No. 60/773,661, filed on Feb. 16, 2006.

(51) Int. Cl. G06Q 30/00

(52) U.S. Cl. 705/14

(57) ABSTRACT

Many customers are members of multiple frequent customer programs. When a customer wishes to book reward travel, searching each frequent customer program of which the customer is a member is difficult and time-consuming. A rewards program provider, such as a transactional account company, can provide members the opportunity to link frequent customer programs to the rewards program. When a customer searches for reward travel, the customer enters the request through the rewards program provider. The rewards program provider then sends a request to each frequent customer program which includes the customer identification. The frequent customer programs each return a search result tailored to the specific customer, taking into consideration the customer's status and point balance in the frequent customer program. The rewards program provider then allows the customer to book a selected reservation using points corresponding to a specific frequent customer program and/or points corresponding to the provider's rewards program.

### CROSS REFERENCE TO RELATED CASES

The present application is a non-provisional of U.S. Provisional Application No. 60/773,661 filed Feb. 16, 2006, which is incorporated herein by reference in its entirety.

### BACKGROUND OF THE INVENTION

1. Field of the Invention

The present invention relates to rewards programs, such as rewards programs associated with a transactional account, and frequent customer programs, such as frequent flier and frequent guest programs.

2. Background Art

Many consumers are members of one or more frequent customer programs, such as frequent flyer rewards programs sponsored by airlines or frequent guest programs sponsored by hotels. If a consumer participates in multiple frequent customer programs, the consumer typically has to search each program individually to find an itinerary that meets their needs and reflects to them the best value for the points they have earned in each program. This makes it difficult for the consumer to easily find and book reward travel.

There are currently no solutions in the marketplace to address this problem. Some transactional account rewards programs, such as those that offer rewards for credit card usage, offer airline tickets and/or hotel rooms that are purchased for cash by the rewards program directly instead of redeeming enrollees' frequent customer program points and transferring them to the specific airline or hotel frequent customer program. This does not help customers who want to transfer their points earned in the frequent customer program and find available reward travel options through the specific frequent customer programs. What is needed is a system and method that allows a customer to easily search all frequent customer programs of which the customer is a member or could become a member, while still allowing the customer to redeem miles and/or points earned in the selected frequent customer program.

### BRIEF SUMMARY OF THE INVENTION

An end-to-end solution to the above problem allows members of a comprehensive rewards program associated with a transactional account company to search, potentially transfer points, and book reward travel directly through the rewards program website. A comprehensive rewards program, as the term is used herein, is a rewards program where points are redeemable for any type of good or service, such as, for example and without limitation, airline tickets, hotel rooms, electronics and other consumer goods, retail gift certificates, etc. The comprehensive rewards program provider is partnered with one or more service providers having associated frequent customer programs. A frequent customer program, as the term is used herein, is a rewards program for a specific good or service. Examples of frequent customer programs include, without limitation, frequent flyer programs which redeem points (also known as miles) for airline tickets, and frequent guest programs which redeem points for hotel rooms. Because of the partner relationship between the comprehensive rewards program provider and service providers associated with the frequent customer programs, the frequent customer programs interact directly with the comprehensive rewards program. The comprehensive rewards program thus becomes a search and booking tool for its participants.

Once enrolled in the comprehensive rewards program, a participant links any frequent customer program in which the participant is enrolled to the comprehensive rewards program. When reward travel is desired, the participant uses the comprehensive rewards program to define the terms of the search. The comprehensive rewards program provider then requests a search from each of its partner service providers according to the participant-defined search terms. The comprehensive rewards program provides results of the search to the participant. If the participant is a member of any frequent customer program associated with the service providers searched, the participant's status in the frequent customer program is taken into consideration when performing the search. Additionally, the available point balance in the frequent customer program(s) is provided to the participant. However, results can also be displayed for frequent customer programs of which the participant is not yet a member or which they have not yet linked to the comprehensive rewards program.

The participant selects a travel option through the comprehensive rewards program. The comprehensive rewards program then requests booking of the selected travel option by the partner service provider. If the participant has available points in the frequent customer program associated with the selected service provider, the participant's frequent customer program account point balance is reduced accordingly. Additionally or alternatively, if the participant has a balance of points in the comprehensive rewards program that can be transferred to the selected service provider, the participant's points are reduced and transferred accordingly. The participant will also have the capability to decide how many points they want to use from either the frequent customer program and/or from the comprehensive rewards program to complete the booking. Providing the participant with a portal with which the participant can search, transfer, and book with multiple frequent customer programs at one time greatly reduces the time and effort required to find available travel rewards which meet the participant's desired or required itinerary needs and available point levels. The search, transfer, and book functionality also is enabled in real, or near-real, time to the participant, further improving the participant's redemption experience.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a high level block diagram of an example search, transfer, and booking tool.

FIG. 2 is a flowchart of an example method for searching for and booking reward travel through the search, transfer, and booking tool of FIG. 1.

FIG. 3 is a flowchart of an example method for searching for and booking reward travel through a website of the search, transfer, and booking tool of FIG. 1 by a user.

FIG. 4 is a block diagram of an exemplary computer system useful for implementing the present invention.

FIGS. 5 through 22 are screenshots of example web pages that may appear based on user selections within the search, transfer, and booking tool.

The present invention will be described with reference to the accompanying drawings. The drawing in which an element first appears is typically indicated by the leftmost digit(s) in the corresponding reference number.

### DETAILED DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer”, “customer,” “participant,” “cardmember,” and/or the plural form of these terms are used interchangeably throughout herein to refer to those persons or entities capable of accessing, using, being affected by and/or benefiting from the tool that the present invention provides for accessing multiple frequent customer programs.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

2. Open Versus Closed Cards

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

4. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

5. Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄ N₅N₆N₇N₈ N₉N₁₀N₁₁N₁₂ N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember.

A merchant account number may be, for example, any number or alpha-numeric characters that identifies a particular merchant for purposes of card acceptance, account reconciliation, reporting and the like.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

II. Search, Transfer, and Booking Systems and Methods

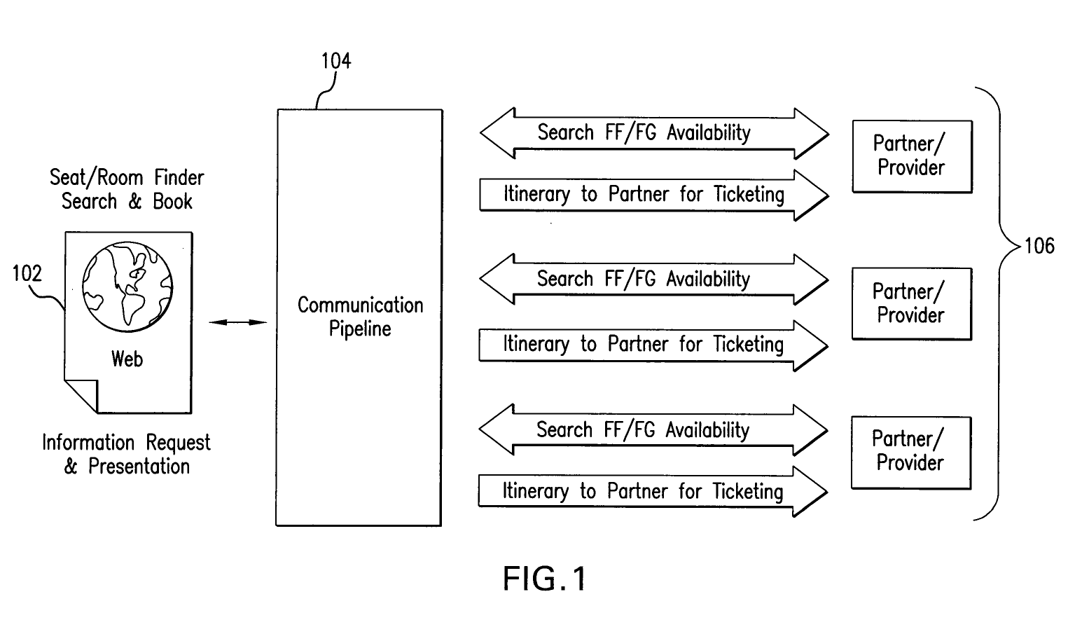

FIG. 1 is a high-level diagram of the interactions between a participant, a comprehensive rewards program provider, and one or more partner service providers. The service providers may have associated frequent customer programs. A comprehensive rewards program (“CRP”), as the term is used herein, is a rewards program where points are redeemable for any type of good or service, such as, for example and without limitation, airline tickets, hotel rooms, rental cards, electronics and other consumer goods, retail gift certificates, etc. The comprehensive rewards program provider may be, for example, a transactional account company such as American Express Co., of New York, N.Y., with points earned in the comprehensive rewards program correlated to spend on a transactional card associated with an account held with the transactional account company. A frequent customer program, as the term is used herein, is a rewards program for a specific good or service. Examples of frequent customer programs include, without limitation, frequent flier programs which redeem points (also known as miles) for airline tickets, and frequent guest programs which redeem points for hotel rooms.

A comprehensive rewards program participant interface 102 interacts with partner service providers 106 through a communication pipeline 104. Communication pipeline 104 enables direct communication between participant interface 102 and partner service providers 106.

A participant interacts with participant interface 102. The participant may be, for example, a holder of a transactional card from the transactional account company. Participant interface 102 may be a web page interface or it may be a person-to-person interface, such as through a telephone line. The participant provides information relating to the participant's travel preferences using participant interface 102. Participant interface 102 transfers the participant's travel preferences via communication pipeline 104. Partner service providers 106 search their availability based on the customer's travel preferences to find reward travel availability that matches best with the travel preferences. For example, partner service providers 106 search for frequent flier (“FF”) and/or frequent guest (“FG”) availability. Partner service providers 106 send available travel options back through communication pipeline 104 as search results. Communication pipeline 104 groups the results and sends them to the participant through participant interface 102. In this manner, the comprehensive rewards program provider acts as a search, transfer, and booking tool to multiple partner service providers. This process is further detailed below.

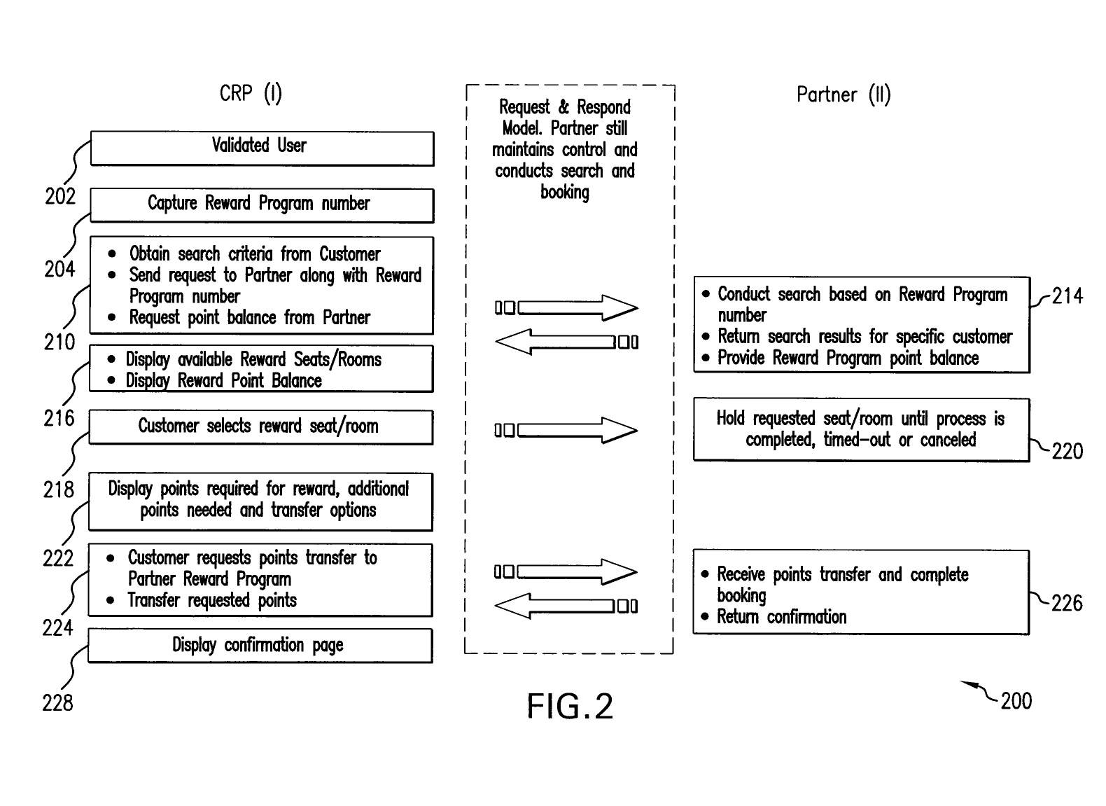

FIG. 2 is a flowchart of a method 200 for booking a participant's reward travel based on options from a number of frequent customer program providers. Column I indicates steps that are taken by the comprehensive rewards program provider. Column II indicates steps that are taken by the partner service providers.

In step 202, a participant is validated. This may occur, for example, when a participant logs into a comprehensive rewards program website, or when the participant contacts a comprehensive rewards program participant representative. This may also occur if the participant is directed to the comprehensive rewards program website from a partner service provider website. In step 204, the comprehensive rewards program provider captures the participant's identification number for a frequent customer program associated with a partner service provider. This may be done by referencing a participant database to which the participant has provided identification numbers for frequent customer programs of which the participant is a member. Additionally or alternatively, the participant may provide relevant identification numbers during step 204.

In step 210, the comprehensive rewards program provider obtains search criteria from the participant. The search criteria may include a type of travel, such as air, hotel, rental car, or any combination thereof. The search criteria may also include, for example and without limitation, a number of points required for redemption, specific dates, flexible dates, specific times for air flights, flexible times for air flights, specific airports and/or cities, airports and/or cities within a given mile range, multiple airport search, multiple destination search, nearby address or landmark, multiple reservations, specific partner service providers, partner service providers linked to the participant's comprehensive rewards program account, all participating partner service providers, roundtrip air flight, one way air flight, direct flights only, or seat class options (e.g., economy/coach, business, or first class). The comprehensive rewards program provider formulates the participant travel preferences into a request for each partner service provider, and sends the requests to each respective partner service provider. The comprehensive rewards program provider also requests point balances from all partner service providers having frequent customer programs of which the participant has been identified as a member.

In step 214, the partner service provider conducts a search of available travel options based on the frequent customer program identification provided to the partner service provider by the comprehensive rewards program provider. This identification can either be for the specific participant (e.g., their personal frequent flyer or frequent guest identification number) or based on a generic frequent customer program identification (e.g., the lowest status available in the partner service provider's frequent customer program) that is available and/or established for the comprehensive rewards program provider.

Because the partner service provider performs the search based on the request from the comprehensive rewards program provider, the comprehensive rewards program provider does not require direct access to the partner service provider's proprietary systems. Search results customized to the specific participant may then be returned from the partner service provider to the comprehensive rewards program provider. Alternatively, search results are returned based on the comprehensive program provider's generic frequent customer program identification. One example of customized search results are search results based on the status of the participant with the service provider's frequent customer program. For example, if the participant has ‘elite’ status with the frequent customer program, the search results returned include availability and redemption options for an elite status customer instead of a basic status customer. As discussed previously, if the participant is not a member of the frequent customer program of the partner service provider searched, the results returned are generic search results. The partner service provider also provides any frequent customer program account point balance for the participant to the comprehensive rewards program provider.

In step 216, the participant is notified of available, customized reward travel options and the participant's reward point balance with the partner service provider. Available and/or optional dates corresponding to the participant's request may be displayed, for example, in a “clickable” calendar format. In step 218, the participant selects an available reward travel option. If an airline flight requires multiple legs, the participant may have the option of selecting the service provider for the first leg. Subsequent leg listings may then be limited to the selected service provider. In step 220, once the reward travel option has been selected, the partner service provider may hold the requested travel option open until the booking process is completed, timed-out, or cancelled.

In step 222, the comprehensive rewards program provider notifies the participant of the number of points required for each reward travel option. When additional points are needed to redeem a particular reward travel option, the number of additional points that are needed may be provided to the participant by the comprehensive reward program provider, or transfer options for gathering the needed points may be provided to the participant.

In step 224, the comprehensive rewards program provider receives a request from the participant to transfer points to the frequent customer program associated with the partner service provider selected. The points may be either or both of points associated with the frequent customer program or points associated with the comprehensive rewards program. The comprehensive rewards program provider then complies with the participant's request and requests that the partner service provider complete the booking.

In step 226, the partner service provider receives the points transfer and completes the booking of the reward travel option. The partner service provider then returns a confirmation to the comprehensive rewards program provider. In step 228, the comprehensive rewards program provider notifies the participant of the booking confirmation.

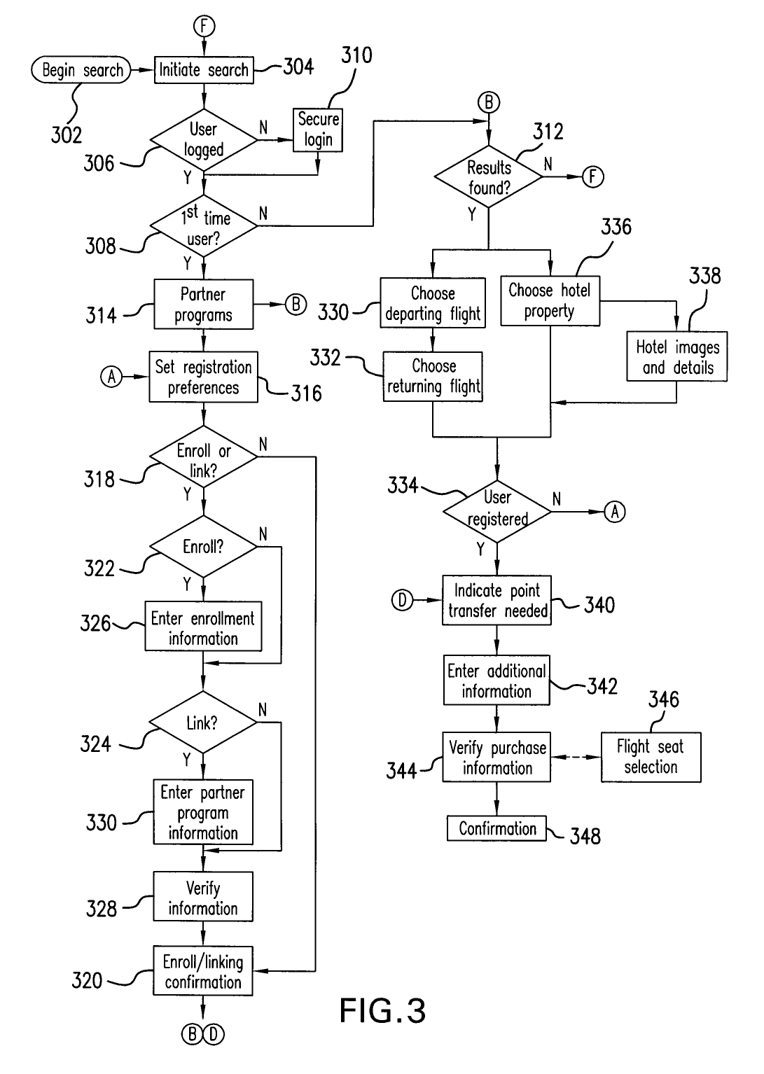

FIG. 3 is a detailed flowchart from a participant's perspective of a process 300 for booking the participant's reward travel through a comprehensive rewards program's search, transfer, and booking tool. Although FIG. 3 is described with respect to a web-based booking process, one of skill in the pertinent art(s) will recognize that a similar process could be used when a participant contacts a comprehensive rewards program service representative directly (e.g., via telephone). In that case, the service representative has access to all features of the process described herein. In step 302, the participant arrives at the comprehensive rewards program homepage. In step 304, the participant identifies the type of travel that the participant is searching for. For ease of description, process 300 will be described with respect to searching for and booking either flights or hotel rooms, although one of skill in the relevant art(s) will recognize that a similar process can be used for searching for and booking other types of travel, such as rental cars, without departing from the spirit and scope of the present invention. Thus, in process 300, the participant selects either a flight search or a hotel search in step 304.

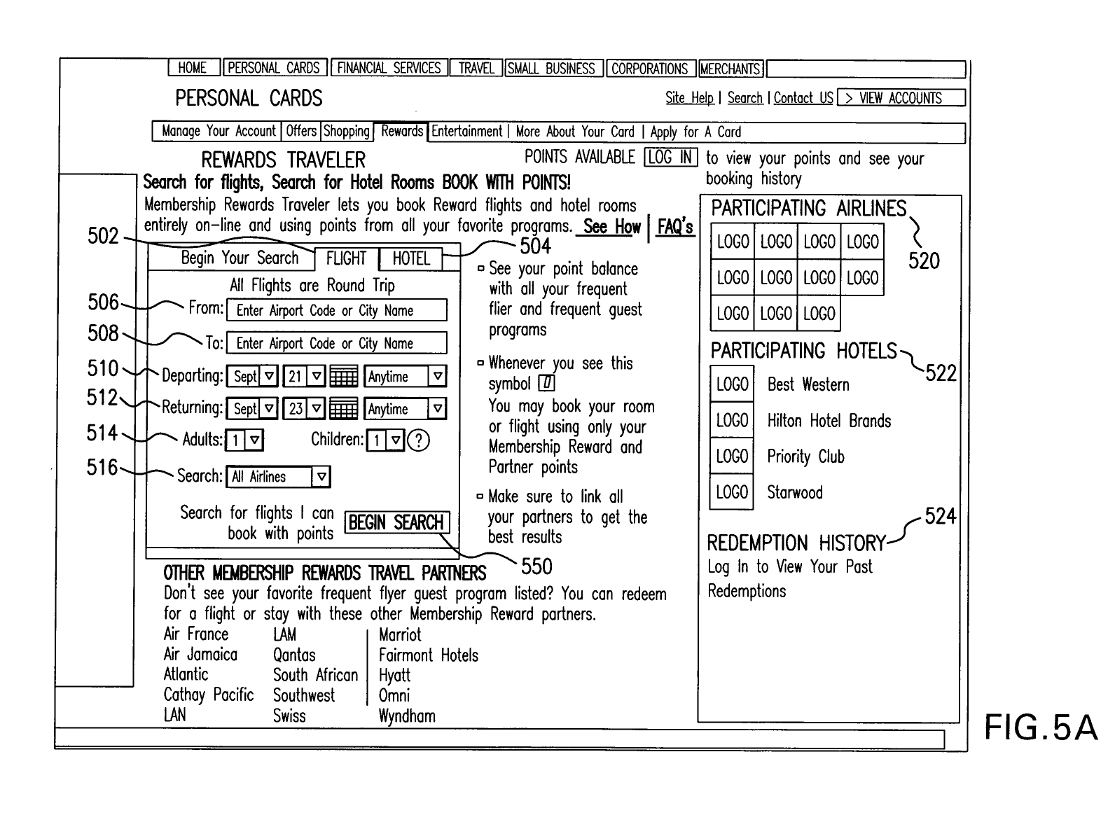

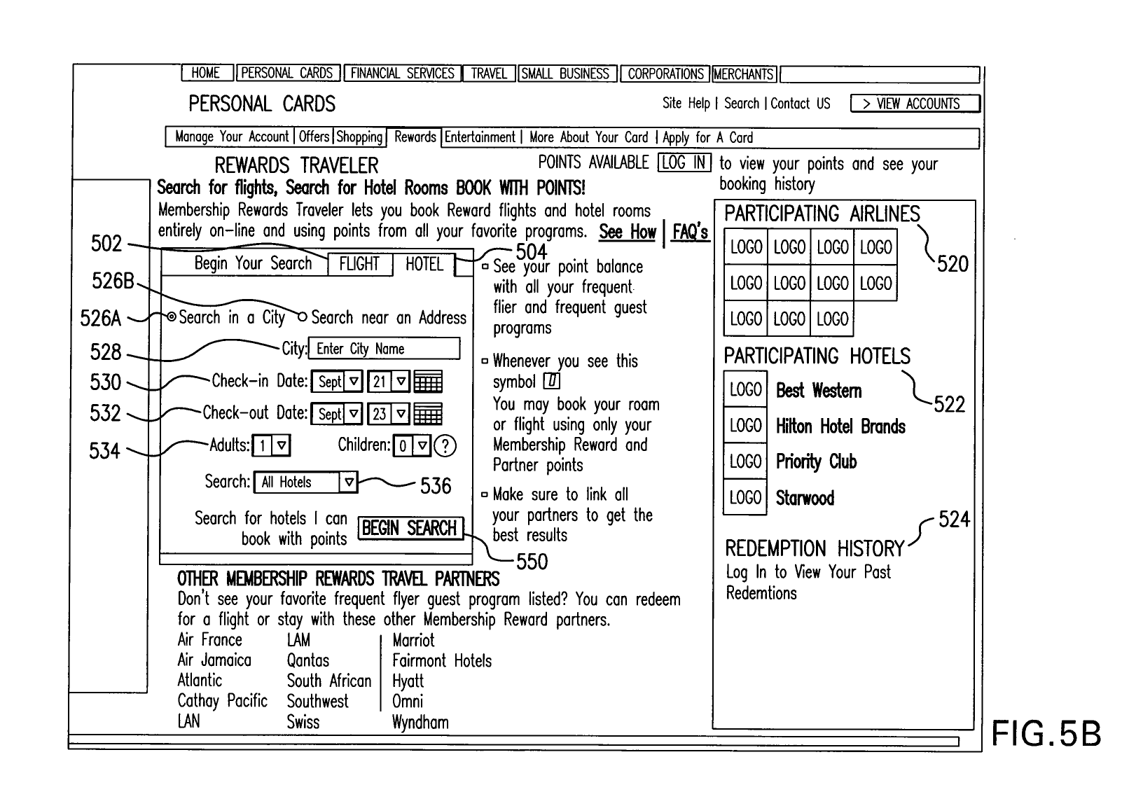

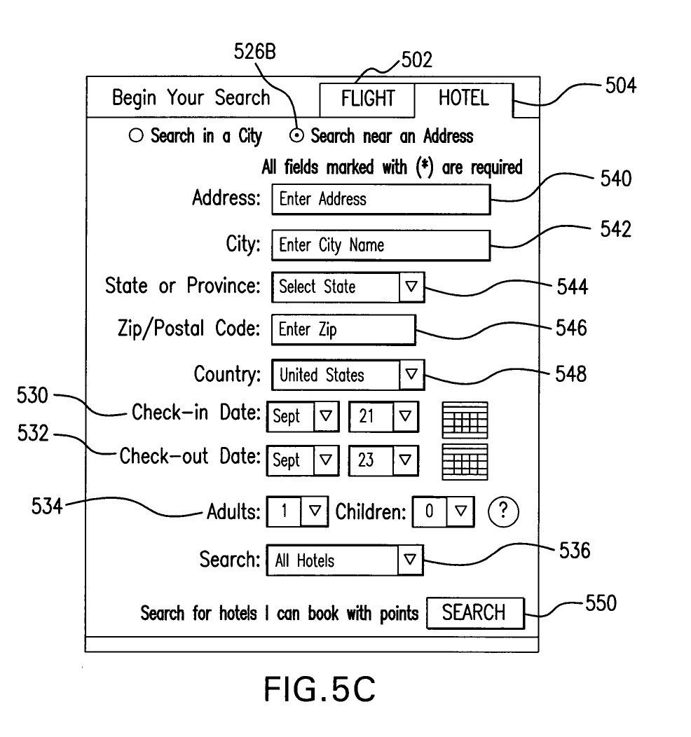

FIG. 5A is a screenshot of an example web page 500 that may be displayed to the participant during step 304. Web page 500 includes a flight tab 502 and a hotel tab 504. Flight tab 502 includes a departure location entry field 506, a destination location entry field 508, a departure date entry field 510, a return date entry field 512, a number of passengers entry field 514, and an airline service provider entry field 516. One or more of the entry fields may be, for example and without limitation, text boxes or drop-down lists containing specific selections. Date entry fields 510 and 512 may include calendar selectors which, when selected, open a calendar view from which the participant may select dates of travel. Number of passengers entry field 514 may include separate entry fields for indicating the number of adult passengers and child passengers.

Web page 500 may also include a participating airlines section 520 and a participating hotels section 522, indicating which airlines and/or hotels offer travel options through the comprehensive rewards program. Web page 500 may also include a redemption history section 524, specific to the participant, which lists previous bookings made by the participant.

FIG. 5B is another screenshot of example web page 500, with hotel tab 504 displayed. Hotel tab 504 includes a selector 526A which is selected when the participant wishes to search for a hotel room in a specific city, and a selector 526B which is selected when the participant wishes to search near an address. When selector 526A is selected, hotel tab 504 includes a location entry field 528, a check-in date entry field 530, a check-out entry field 532, a number of guests entry field 534, and a hotel service provider entry field 536. One or more of the entry fields may be, for example and without limitation, text boxes or drop-down lists containing specific selections. Date entry fields 530 and 532 may include calendar selectors which, when selected, open a calendar view from which the participant may select dates of travel. Number of guests entry field 534 may include separate entry fields for indicating the number of adult guests and child guests.

FIG. 5C is a screenshot of hotel tab 504 when selector 526B is selected. When selector 526B is selected, hotel tab 504 includes an address entry field 540, a city entry field 542, a state or province entry field 544, postal code entry field 546, and country entry field 548. Hotel tab 504 also includes date entry fields 530 and 532, number of guests entry field 534, and hotel service provider entry field 536.

Once the participant has entered the requested information on web page 500, the participant initiates a search based on the entered information by, for example, selecting a “begin search” link 550.

Returning to FIG. 3, after the participant initiates a search in step 304 by, for example, selecting “begin search” link 550 on web page 500, method 300 proceeds to step 306. In step 306, it is determined whether the participant is logged into the comprehensive rewards program interface. If the participant is logged in, method 300 proceeds to step 308. If the participant is not logged in, method 300 proceeds to step 310, in which the participant logs in through a secure login procedure. The secure login procedure may be any type of secure login procedure known to one of skill in the relevant art(s). Once the participant is logged in, method 300 proceeds to step 308.

In step 308, it is determined whether the participant is using the tool for the first time. If it is determined in step 308 that the participant is not using the tool for the first time, method 300 proceeds to step 312. If it is determined that the participant is using the tool for the first time, method 300 proceeds to step 314.

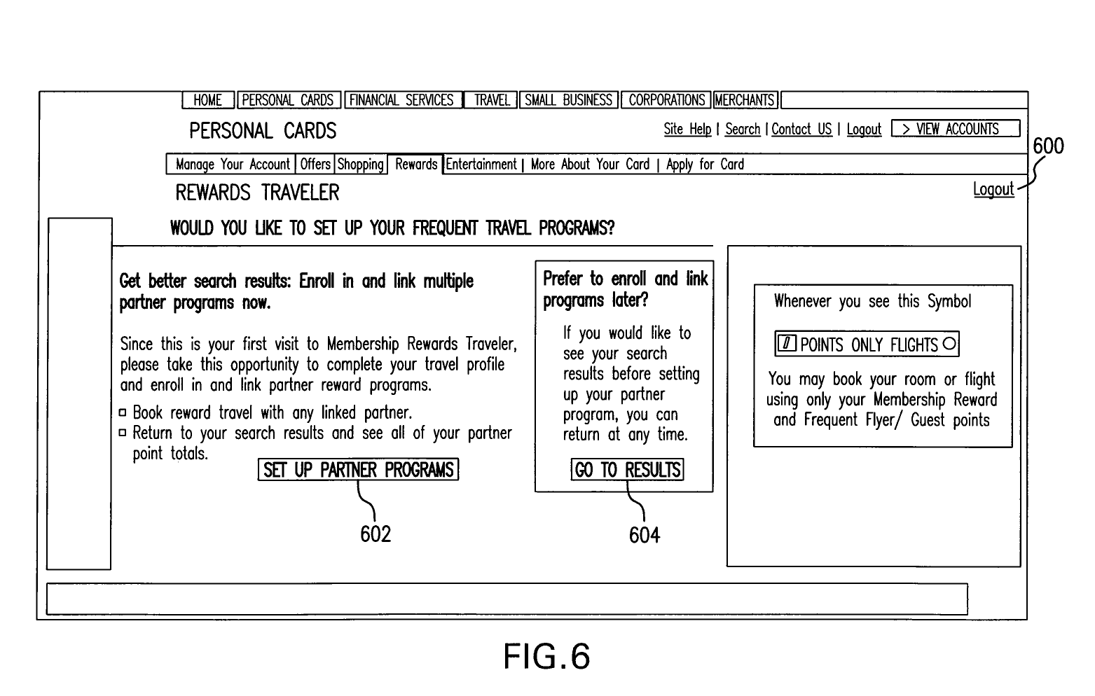

In step 314, the participant is notified of the benefits of enrolling and linking partner frequent customer programs with the participant's comprehensive rewards program account. FIG. 6 is a screenshot of an example web page 600 that may be displayed during step 314. Web page 600 includes a partner programs link 602 that is chosen when the participant decides to enroll in or link one or more partner frequent customer programs. Web page 600 also includes a results link 604 that is chosen when the participant decides not to enroll in or link any partner frequent customer programs. Returning to FIG. 3, if the participant chooses not to enroll in or link any partner frequent customer programs, method 300 proceeds to step 312. If the participant chooses to enroll in or link one or more partner frequent customer programs, method 300 proceeds to step 316.

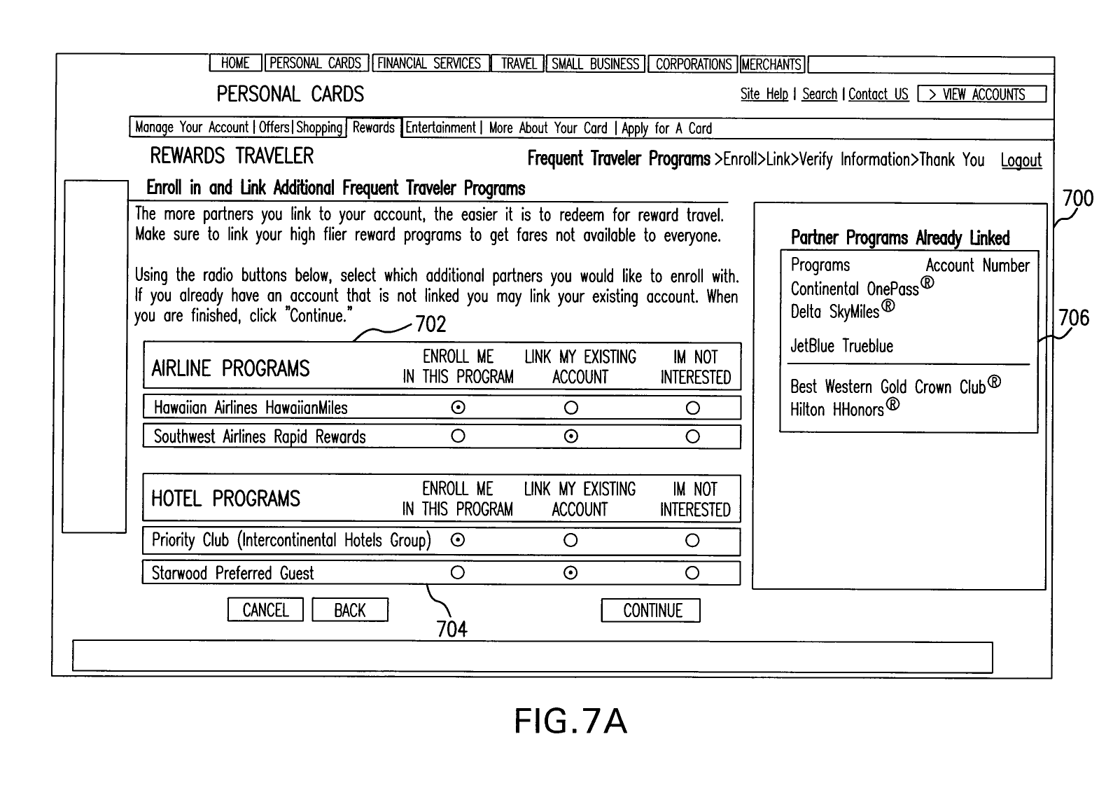

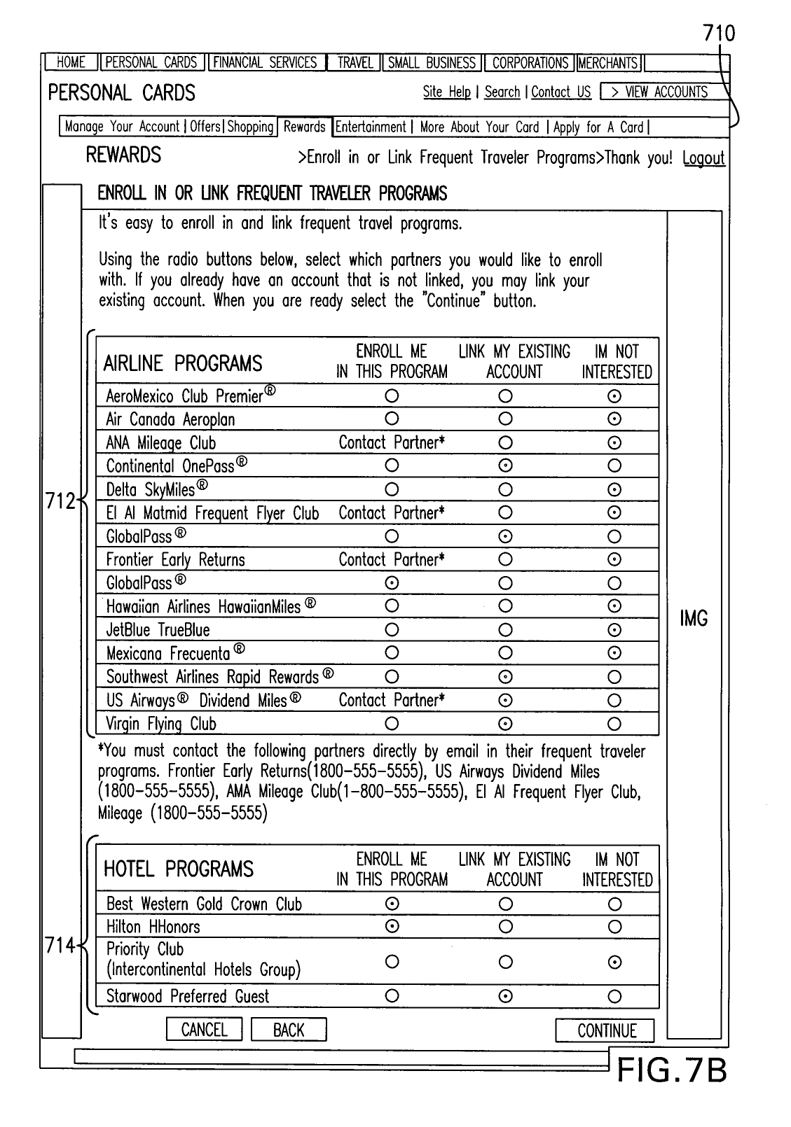

In step 316, the participant sets registration preferences for one or more partner frequent customer programs. FIG. 7A is a screenshot of an example web page 700 that may be displayed during step 316. Web page 700 includes an available frequent flyer programs section 702, an available frequent guest program section 704, and a currently linked programs section 706.

Available frequent flyer programs section 702 lists one or more partner airline service providers that have not yet been linked to the participant's comprehensive rewards program account. Section 702 may include selections allowing the participant to indicate an action to be taken for each listed service provider, such as enrolling in a partner frequent flyer program, linking an existing frequent flyer account, and remaining unconnected with a particular service provider. Similarly, section 704 lists one or more partner hotel service providers that have not yet been linked to the participant's comprehensive rewards program account. Section 704 may also include selections allowing the participant to indicate an action to be taken for each listed service provider. Section 706 lists frequent customer programs that have already been linked to the participant's comprehensive rewards program account, along with specific account numbers assigned to the participant. With web page 700, a participant can only enroll in or link a program that has not already been linked to the participant's comprehensive rewards program account.

FIG. 7B is a screenshot of an alternative web page 710 that may be displayed during step 316. Web page 710 includes an available frequent flyer programs section 712 and an available frequent guest programs section 714. Web page 710 displays all partner service providers that support linking and/or enrolling through the comprehensive rewards program, and a participant can enroll in or link additional frequent customer programs for any partner service provider, including those which have already been linked.

Returning to FIG. 3, once the participant has set registration preferences for one or more partner service providers in step 316, method 300 proceeds to step 318. In step 318, it is determined whether the participant selected to enroll in or link at least one partner frequent customer program. If it is determined that the participant did not select to enroll in or link at least one partner frequent customer program, method 300 proceeds to step 320. If it is determined in step 318 that the participant did select to enroll in or link at least one partner frequent customer program, method 300 proceeds to step 322.

In step 322, it is determined whether the participant selected to enroll in at least one frequent customer program. If it is determined that the participant did not select to enroll, method 300 proceeds to step 324. If it is determined that the participant did select to enroll, method 300 proceeds to step 326.

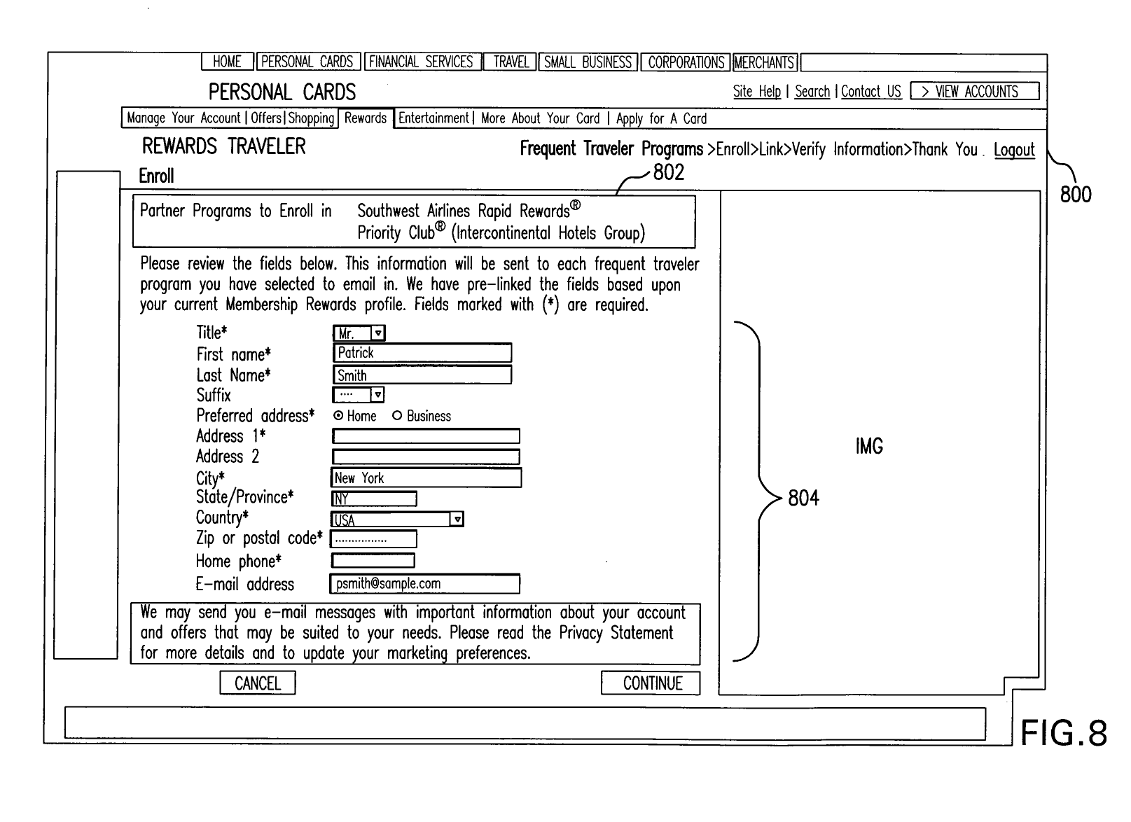

In step 326, the participant enters the participant's enrollment information. FIG. 8 is a screenshot of an example web page 800 that may be used to enter the participant's enrollment information. Web page 800 includes a selected programs section 802 and an information entry section 804. Selected programs section 802 lists the partner frequent customer programs in which the participant selected to enroll. Information entry section 804 provides data entry fields in which the participant can enter the participant's name, address, and contact information.

Returning to FIG. 3, once the participant has entered and verified enrollment information in step 326, method 300 proceeds to step 324. In step 324, it is determined whether the participant selected to link at least one frequent customer program to the comprehensive rewards program. If it is determined that the participant did not select to link, method 300 proceeds to step 328. If it is determined that the participant did select to link, method 300 proceeds to step 330.

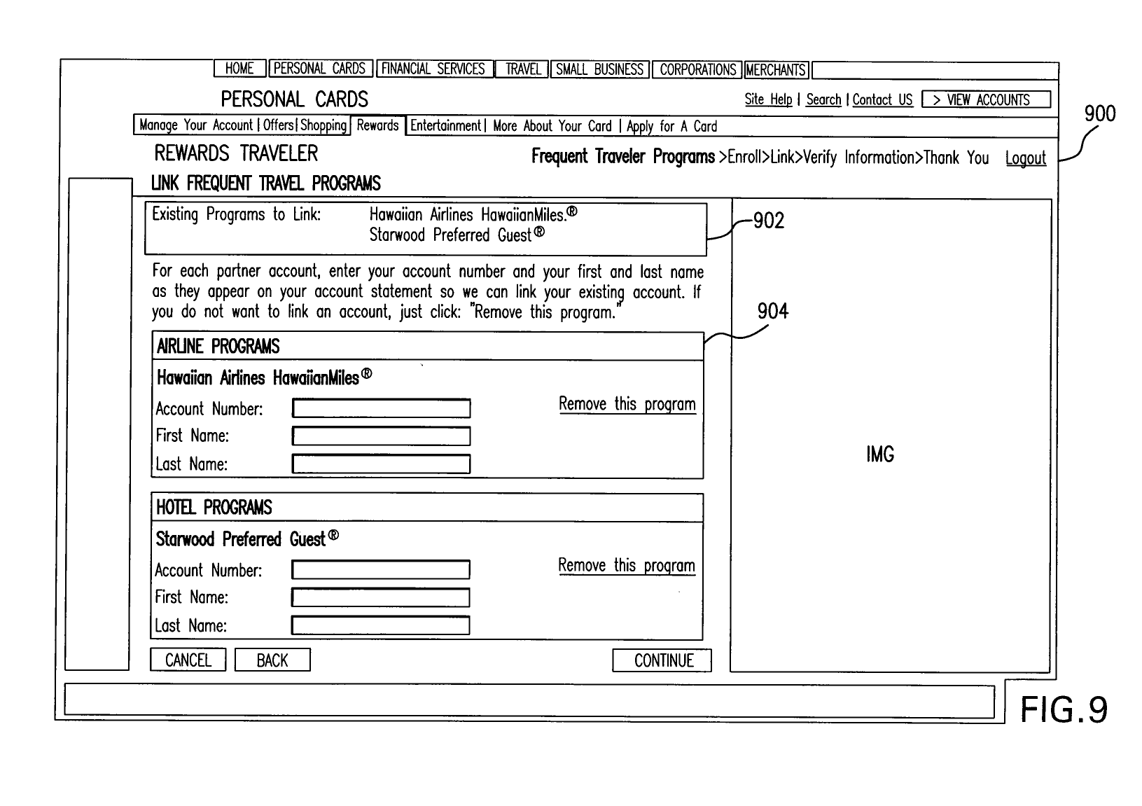

In step 330, the participant enters information for each frequent customer program account to be linked to the participant's comprehensive rewards program account. FIG. 9 is a screenshot of an example web page 900 for entering the account information. Web page 900 includes a selected programs section 902 and an account information entry section 904. Selected programs section 902 lists the partner frequent customer programs in which the participant is already enrolled and has selected to be linked to the comprehensive rewards program account. Account information entry section 904 includes data entry fields for each frequent customer program account requested to be linked to the participant's comprehensive rewards program account. The data entry fields for each account may request information necessary to identify the account with the partner frequent customer program. For example, the information requested may include a frequent customer account number and a first and last name associated with the frequent customer account.

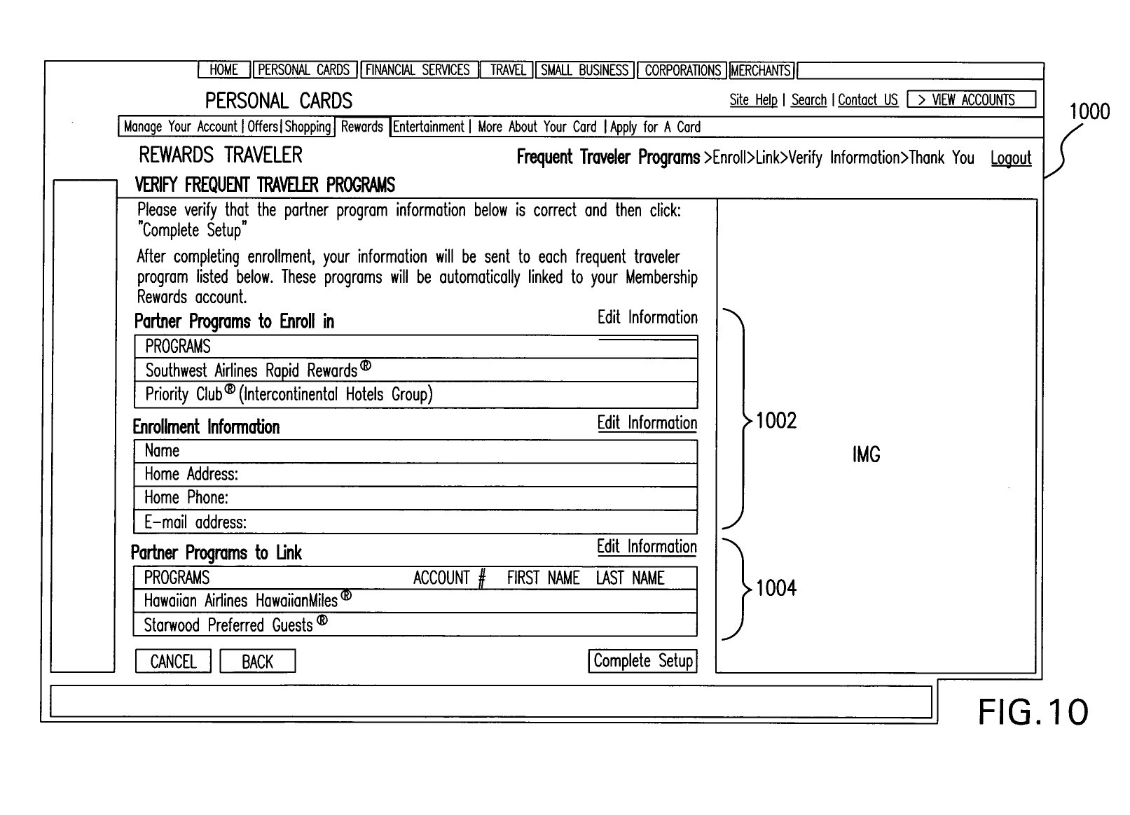

Returning to FIG. 3, once the information for each linked account is entered in step 330, method 300 proceeds to step 328. In step 328, the participant verifies personal information and partner enrollment and/or linking information previously entered. FIG. 10 is a screenshot of an example web page 1000 that may be displayed during step 328. Web page 1000 includes an enrollment section 1002 in which enrollment information entered by the participant can be verified, as well as a link section 1004 in which linking information entered by the participant can be verified. Once the information has been verified by the participant in step 328 of method 300, method 300 proceeds to step 320.

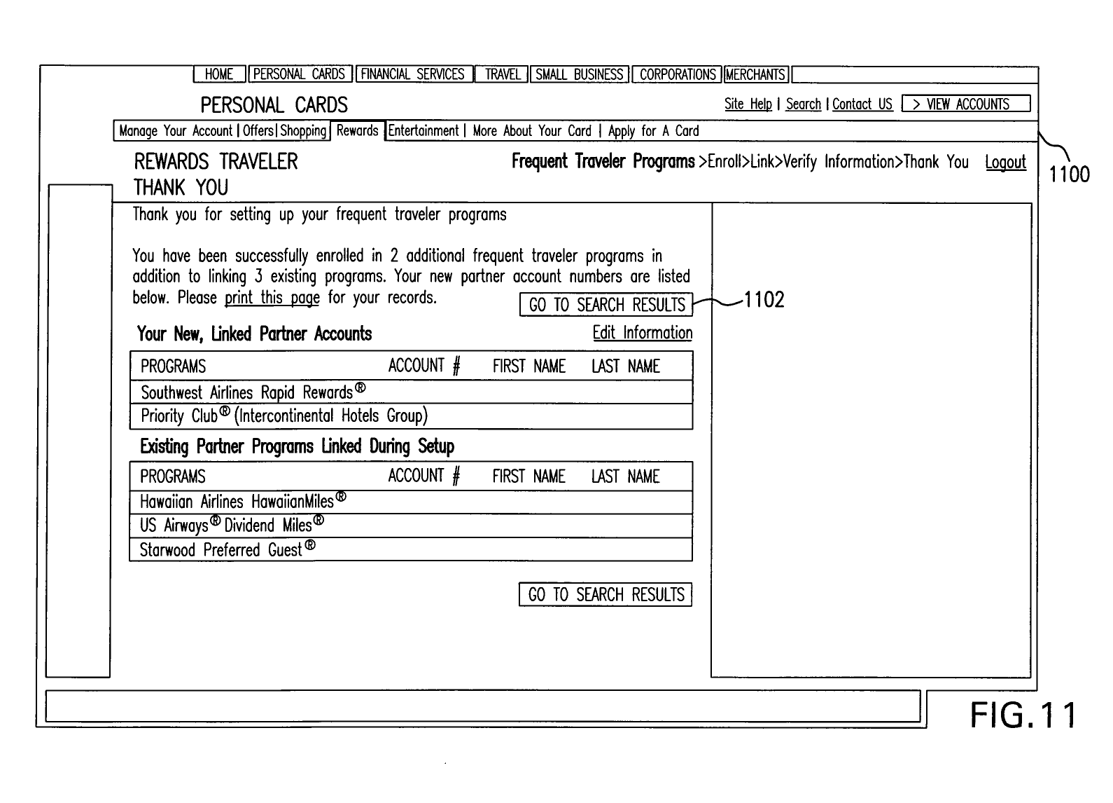

In step 320, a confirmation of the entered information is provided to the participant. FIG. 11 is a screenshot of an example web page 1100 that may be displayed to the participant to provide the confirmation. Any programs in which the participant is newly enrolled are automatically linked to the comprehensive rewards program account. Once the participant is provided with the confirmation, the participant may proceed to reviewing the search results by, for example, selecting search results link 1102. After step 320, method 300 proceeds to step 312.

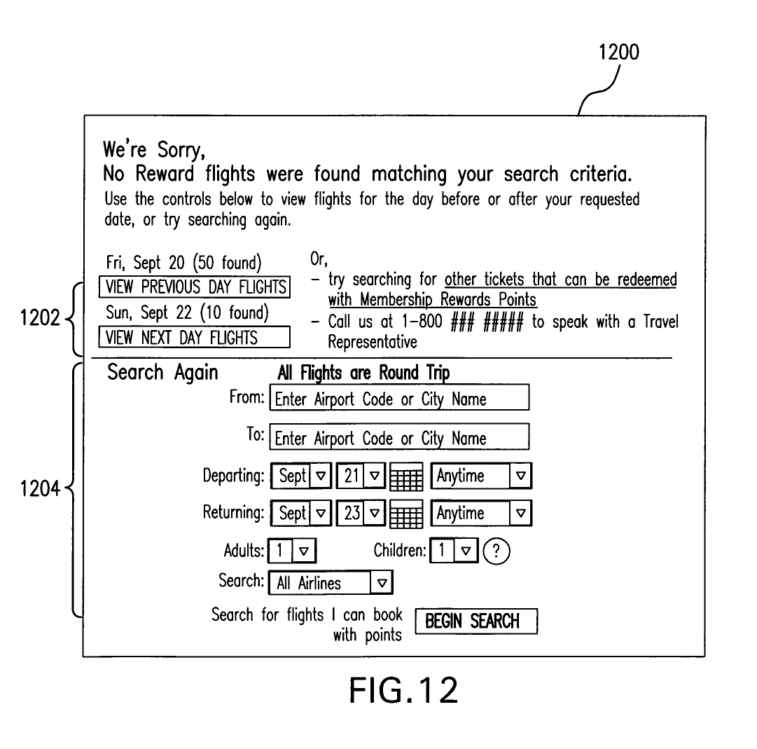

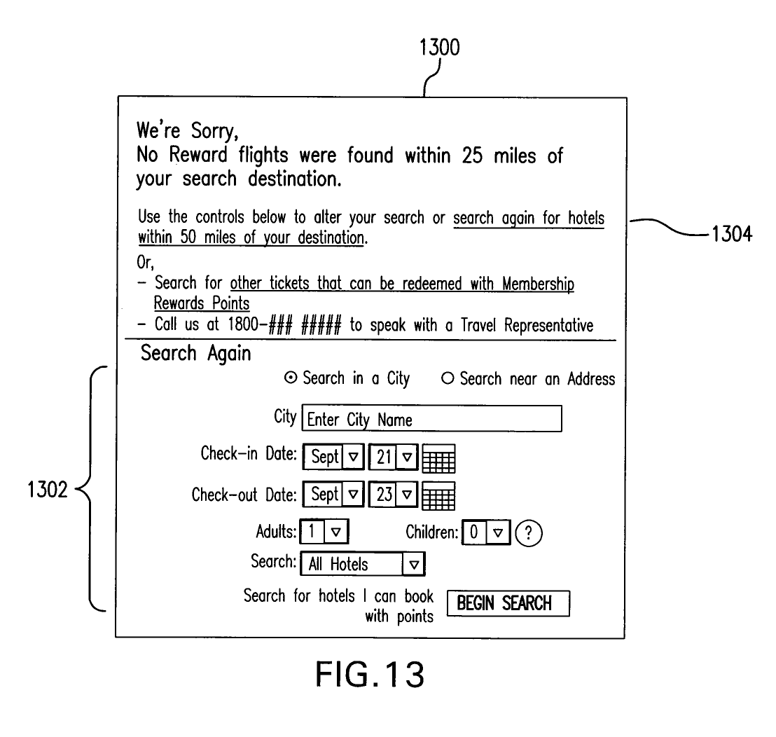

In step 312, it is determined whether any results were found based on the participant's search requirements input in step 304. If it is determined that no results were found, the participant is notified that no results were found, and method 300 returns to step 304. FIG. 12 is a screenshot of an example web page 1200 that may appear when the participant searched for a flight, but no results were returned. Web page 1200 may include an indicator 1202 of flights available on alternate dates, as well as a new search section 1204. New search section 1204 may include the same data entry fields as flight tab 502 on web page 500 (FIG. 5A). Similarly, FIG. 13 is a screenshot of an example web page 1300 that may appear when the participant searched for a hotel room, but no results were returned. Web page 1300 includes a new search section 1302, which may include the same data entry fields as hotel tab 504 on web page 500 (FIG. 5B). Additionally, web page 1300 may include a link 1304 which will re-execute the original search with a broader location range (e.g., hotels within a larger radius of the destination).

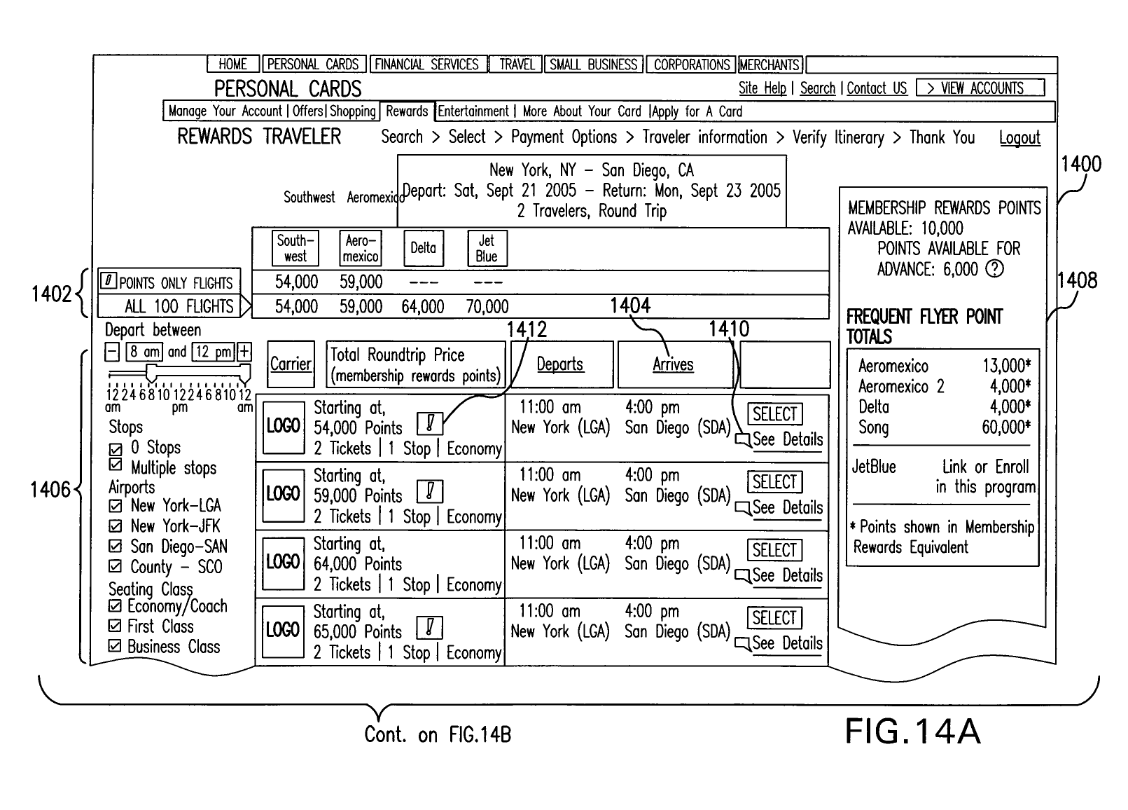

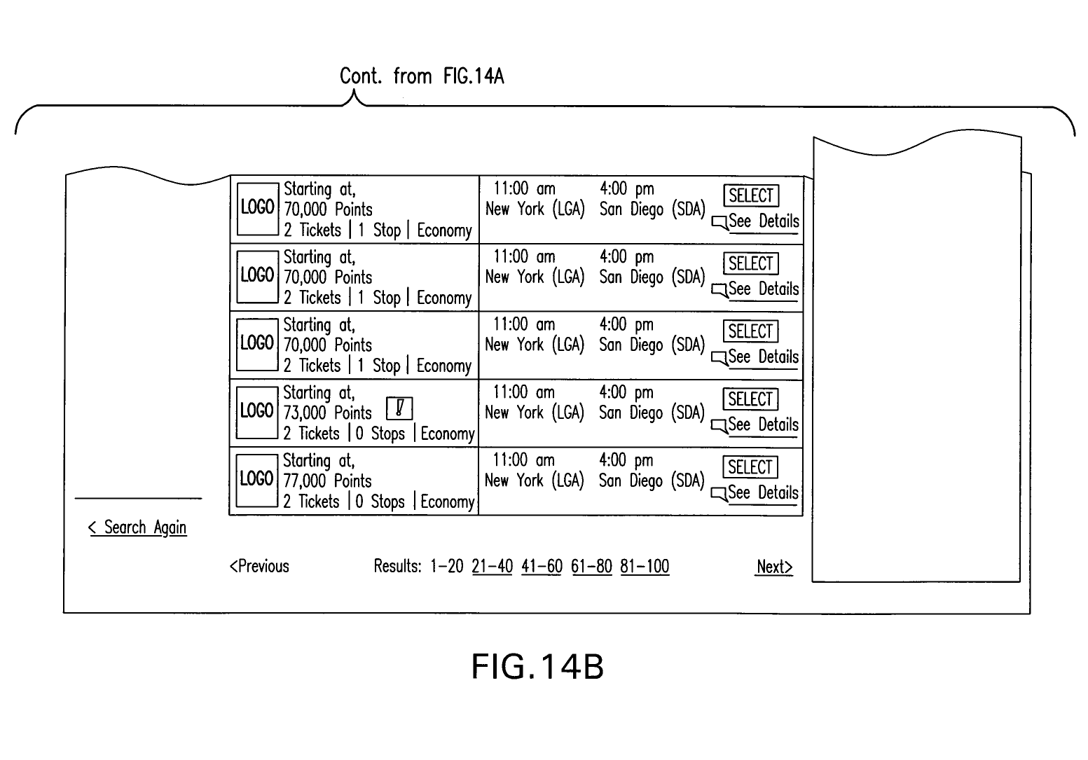

If, in step 312, it is determined that results were found for a flight search initiated by the participant, method 300 proceeds to step 330. In step 330, the participant selects a departing flight. FIG. 14 is a screenshot of an example web page 1400 that may be displayed during step 330. Web page 1400 includes a points needed per airline section 1402 that indicates the number of rewards points needed to obtain a ticket on a given airline. Points needed per airline section 1402 may separately indicate the number of points needed for the participant to redeem a ticket using only the participant's existing rewards points and the number of total points needed for the participant to redeem a ticket on a given airline regardless of the participant's existing rewards points.

Web page 1400 also includes a results section 1404. Results section 1404 lists departure flights available to the participant. Results section 1404 may be organized, for example, based on the number of rewards points required for the participant to redeem the ticket. Each result in results section 1404 may include a details link, such as details link 1410. When a participant clicks on the details link, information about the individual flight may be displayed. For example, the information may include the percentage that the flight departs on-time, whether a meal is served, where a connection is made, the duration of the flight, the distance of the flight, and the type of plane used in the flight. Results section 1404 may also include an indicator, such as indicator 1412, that indicates flights that are available for booking using only existing rewards points.

Web page 1400 also includes a preferences section 1406, which allows the participant to select various options pertaining to the flight, such as departure time range, number of stops, departure airports in a given area, and seating class. Additionally, web page 1400 includes a “dashboard” view 1408 of the participant's accounts that are linked to the comprehensive rewards program and which are relevant to the search results. Dashboard view 1408 may indicate the number of rewards points available to the participant, the number of rewards points that may be advanced to the participant, as well as the rewards point totals for each linked frequent flyer program account. Although accounts from multiple partner service providers may be linked to the comprehensive rewards program, a conversion is applied to point totals from each partner service provider to convert the partner service provider point totals into comprehensive rewards program point totals. The account balance in dashboard view 1408 may thus be indicated in points corresponding to the comprehensive rewards program. The conversion factor applied may be displayed to the participant when the participant selects or scrolls over the account name.

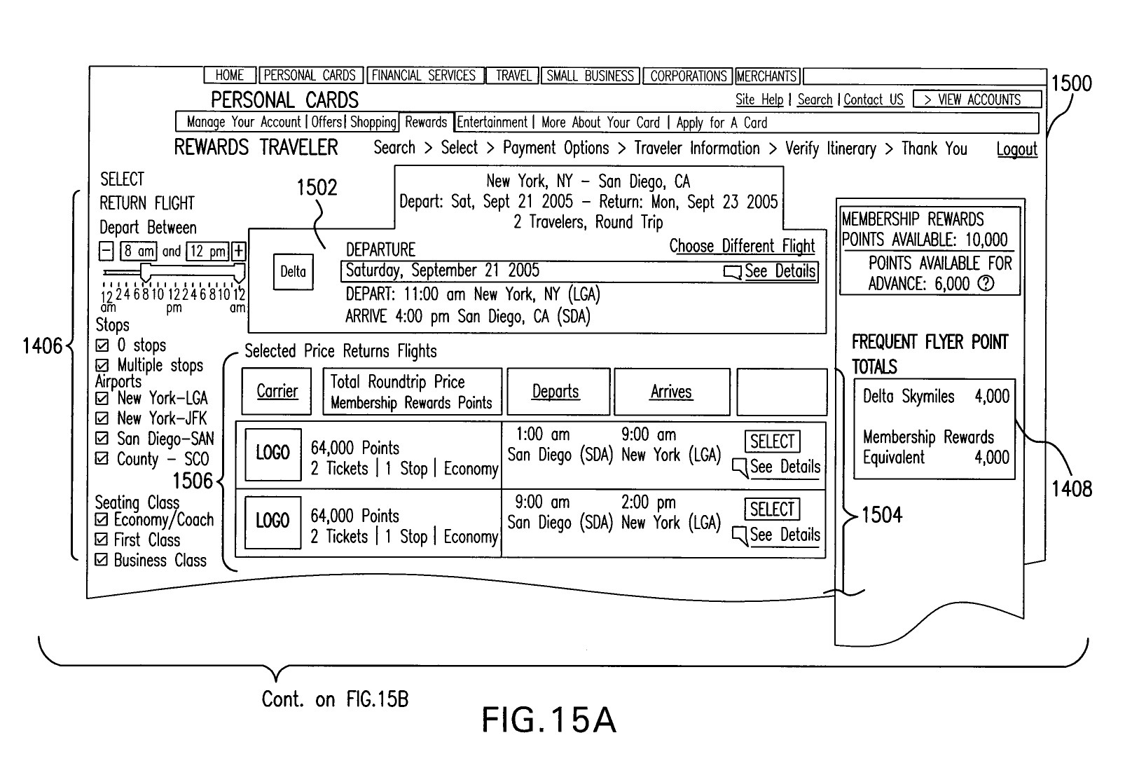

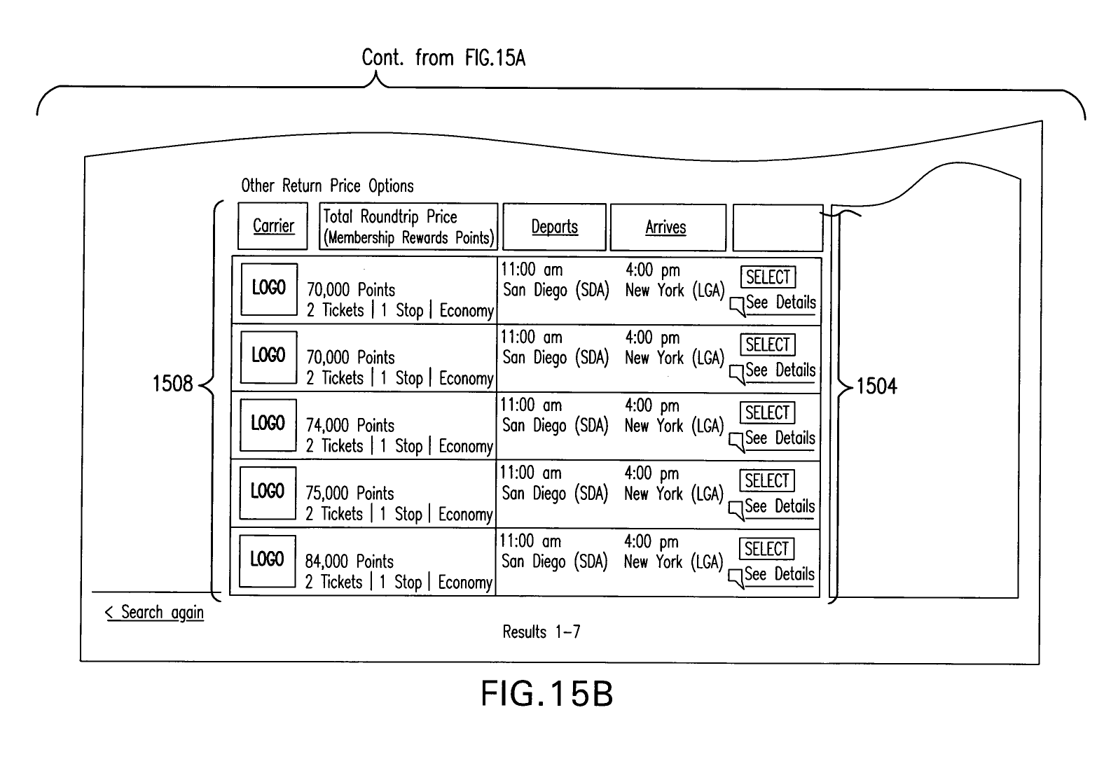

Returning to FIG. 3, once the participant has selected a departure flight in step 330, method 300 proceeds to step 332. In step 332, the participant selects a return flight. FIG. 15 is a screenshot of an example web page 1500 that may be displayed during step 332. Web page 1500 may include a departure section 1502 that displays the participant's selected departure flight. Web page 1500 also includes a results section 1504 that displays available return flights. Results section 1504 may be separated into a selected price section 1506 and an alternate price section 1508. Selected price section 1506 lists flights that are available to the participant for the same number of rewards points that were selected for the departure flight. Alternate price section 1508 lists flights that are available for point totals that are different from the point total needed for the departure flight. Results section 1504 may be automatically filtered to show only flights available with the same partner airline provider selected for the departure flight. Similar to web page 1400, web page 1500 includes preferences section 1406 and dashboard view 1408 (which may be limited to partner point totals relevant to the search results). Once the participant has selected a return flight in step 332, method 300 proceeds to step 334.

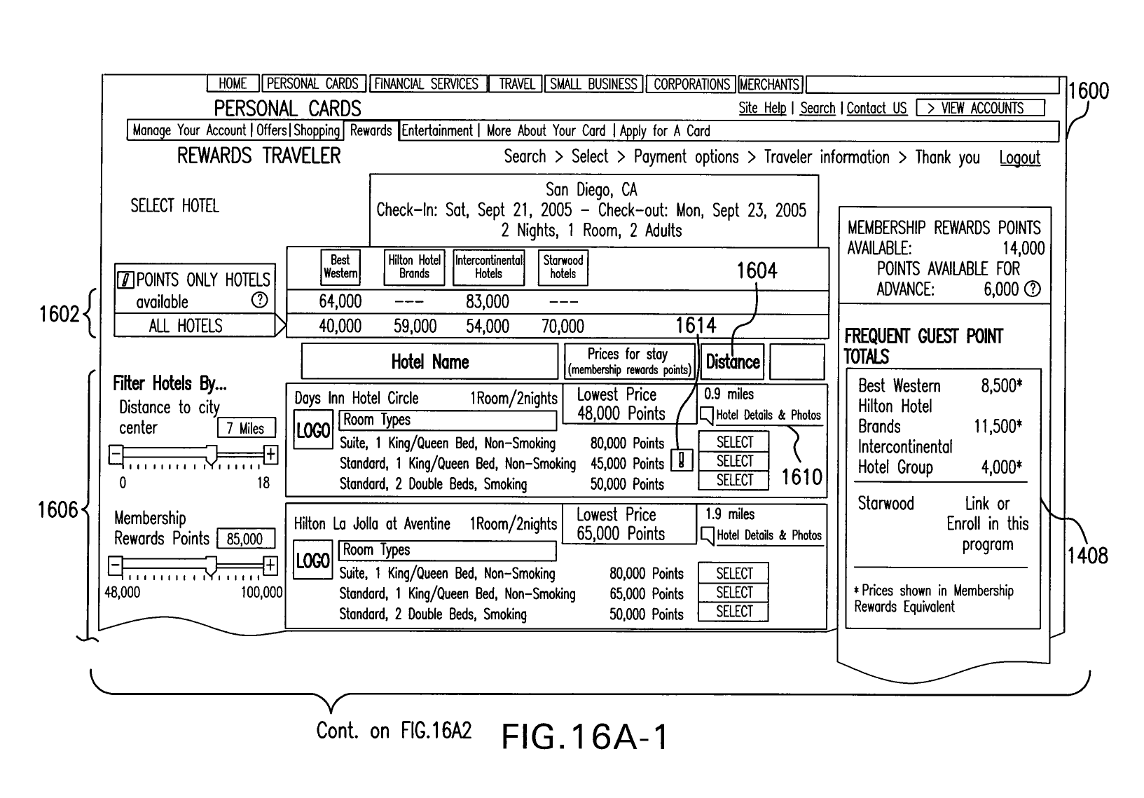

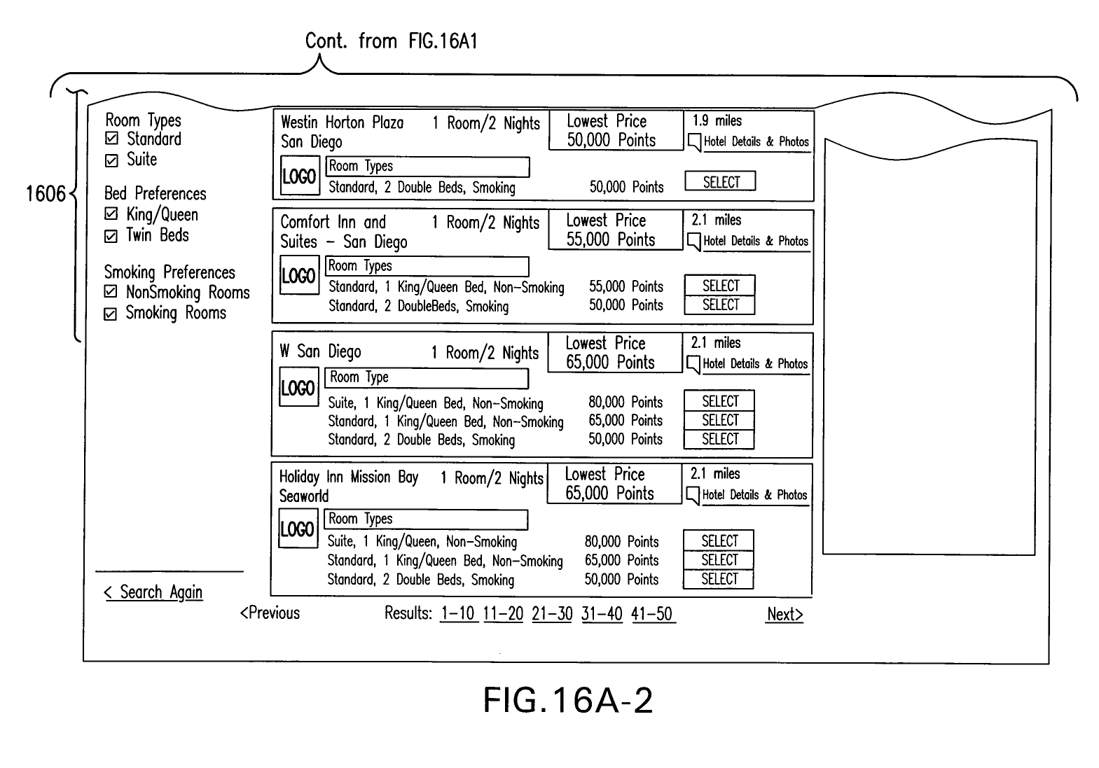

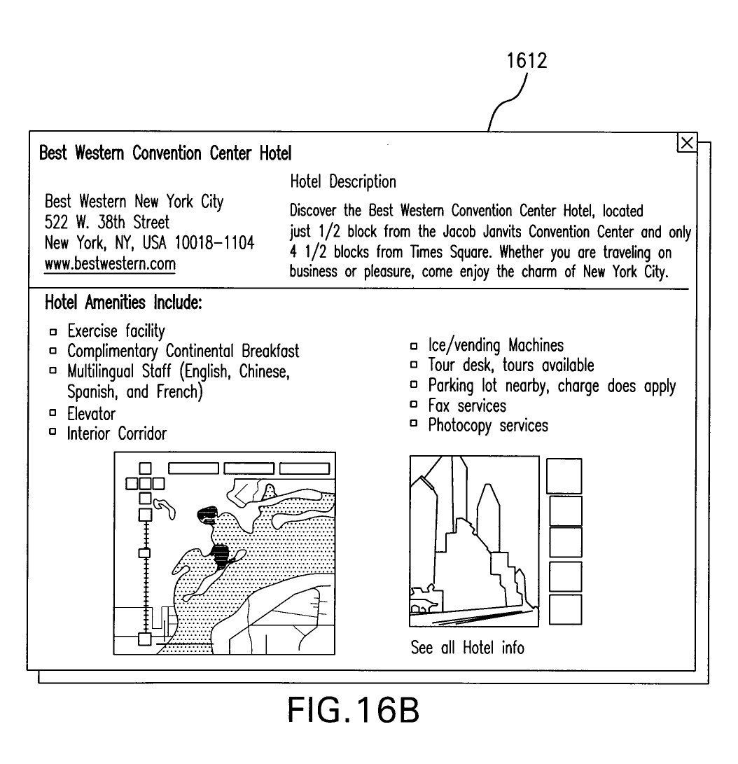

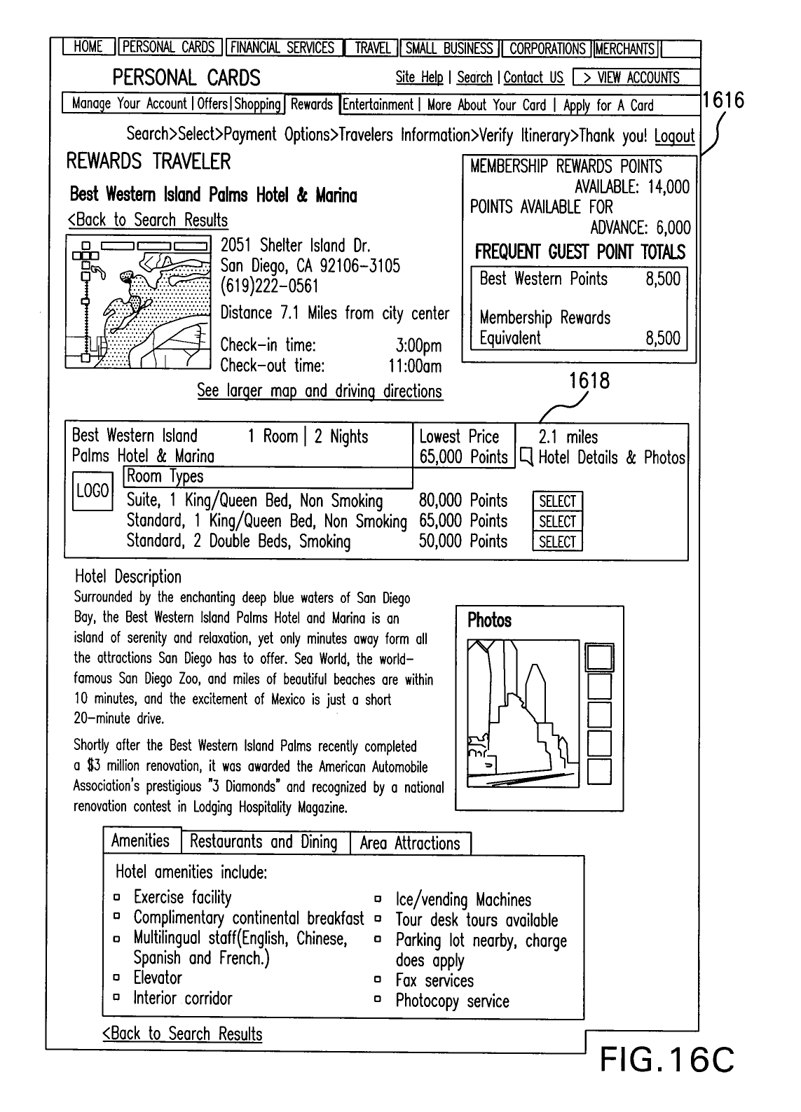

If, in step 312, it is determined that results were found for a hotel room search initiated by the participant, method 300 proceeds to step 336. In step 336, the participant selects an available hotel property from the search results. FIG. 16A is a screenshot of an example web page 1600 that may be displayed to the participant during step 336. Web page 1600 includes a points needed per hotel room section 1602 that indicates the number of rewards points needed to obtain a hotel room with a given hotel company. Points needed per hotel room section 1602 may separately indicate the number of points needed for the participant to redeem a hotel room using only the participant's existing rewards points and the number of total points needed for the participant to redeem a hotel room with a given hotel company regardless of the participant's existing rewards points.

Web page 1600 may also include a results section 1604. Results section 1604 lists hotel rooms available to the participant. Results section 1604 may be organized, for example, based on the number of rewards points required for the participant to redeem the hotel room. Each result in results section 1604 may include a details link, such as details link 1610. When a participant clicks on the details link, information about the given hotel may be displayed. Results section 1604 may also include an indicator, such as indicator 1614, that indicates hotel rooms that are available for booking using only existing rewards points.

Web page 1600 also includes a preferences section 1606, which allows the participant to select various options pertaining to the desired hotel room, such as distance to a given location, number of rewards points required for booking, room type, bed size preference, and smoking preference. Additionally, web page 1600 includes dashboard view 1408 of the participant's accounts that are linked to the comprehensive rewards program and which are relevant to the search results.

If the participant selects a result in results section 1604, method 300 proceeds to step 334. If, however, the participant clicks on a details link, such as details link 1610, method 300 proceeds to step 338. In step 338, further details about a selected hotel are displayed to the participant. An example of the information displayed to the participant after selecting details link 1610 is illustrated in FIGS. 16B and 16C. FIG. 16B is a screenshot of an example pop-up window 1612 that includes an information overview, photographs, and/or maps of the selected hotel. After viewing pop-up window 1612, the participant may close the window and return to web page 1600, or the participant may request additional information regarding the selected hotel. FIG. 16C is a screenshot of an example web page 1616 that may be displayed as an alternative or an addition to pop-up window 1612. Web page 1616 displays detailed information, photographs, and/or maps of the selected hotel. Web page 1616 may also include a room selector 1618 which indicates the types of rooms available at the selected hotel, along with the rewards point total required for redemption, and allows the participant to select a specific room at the hotel. The participant may then either select a specific room or return to the original search results. If the participant decides to return to the original search results, web page 1600 is displayed to the participant. If the participant selects a specific room, method 300 proceeds to step 334.

Returning to FIG. 3, in step 334 it is determined whether the participant is registered for the frequent customer program needed to complete the selected booking. If it is determined that the participant is not registered for the particular frequent customer program, method 300 proceeds to step 316, and the enrollment and/or linking process of the frequent customer program needed proceeds as described above with respect to steps 316 through 320. At this stage, upon completion of step 320, method 300 proceeds to step 340. If it is determined in step 334 that the participant is already registered for the particular frequent customer program needed to complete the selected booking, method 300 proceeds to step 340.

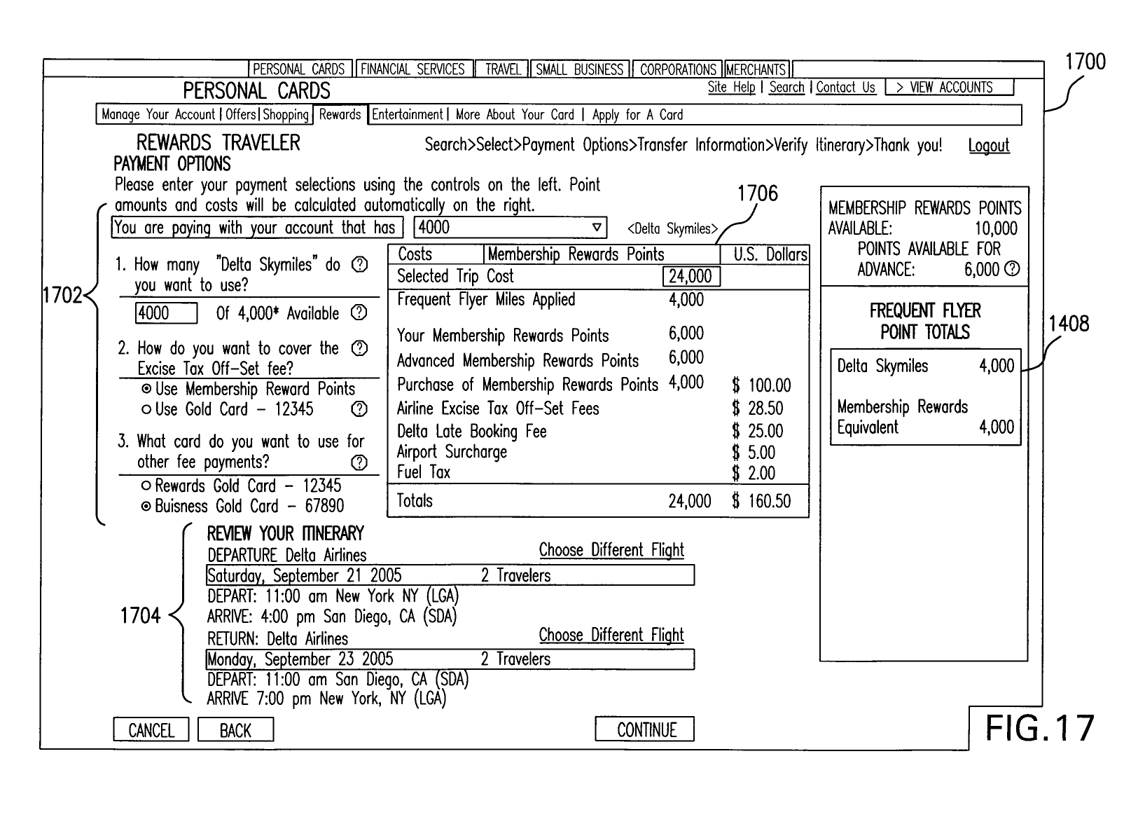

In step 340, the number of rewards points needed to be transferred to the partner frequent customer program is calculated. FIG. 17 is a screenshot of an example web page 1700 that may be displayed during step 340. Web page 1700 includes a payment options section 1702, an itinerary review section 1704, and dashboard view 1408, which now may be limited to the relevant partner for the selected transaction. Payment options section 1702 allows the participant to select payment preferences, such as the number of frequent customer points or miles the participant wishes to use for the travel booking. Depending on the participant's account balance with the frequent customer program, the booking may be made entirely with points from the frequent customer program account, entirely with points from the comprehensive rewards program account, or with a combination of points from both the frequent customer program and comprehensive rewards program accounts. If there is a difference between the number of rewards points needed to complete the booking and the number of rewards points available in the participant's comprehensive rewards program account, the participant may purchase or otherwise obtain (e.g., point advance or reinstatement) additional rewards points from the comprehensive rewards program. Payment options section 1702 may also allow the participant to indicate how additional fees should be paid. For example, some fees, such as excise tax off-set fees, may have the option of being paid with rewards points from the participant's comprehensive rewards program account or via the participant's transaction account that is linked to the comprehensive rewards program account. Other fees may not have the option of being paid with rewards points, but the participant may choose an alternate source of payment, such as a transaction account linked to the comprehensive rewards program account or a non-linked transaction account.

As the participant selects various options in payment options section 1702, a payment summary chart 1706 may be updated to reflect those options. Payment summary chart 1706 may list, for example and without limitation, the number of rewards points used from the participant's account with the partner frequent customer program, the number of rewards points used from the participant's account with the comprehensive rewards program, the number of rewards points purchased by the participant from the comprehensive rewards program, the number of rewards points advanced by the comprehensive rewards program, and any fees associated with the travel booking.

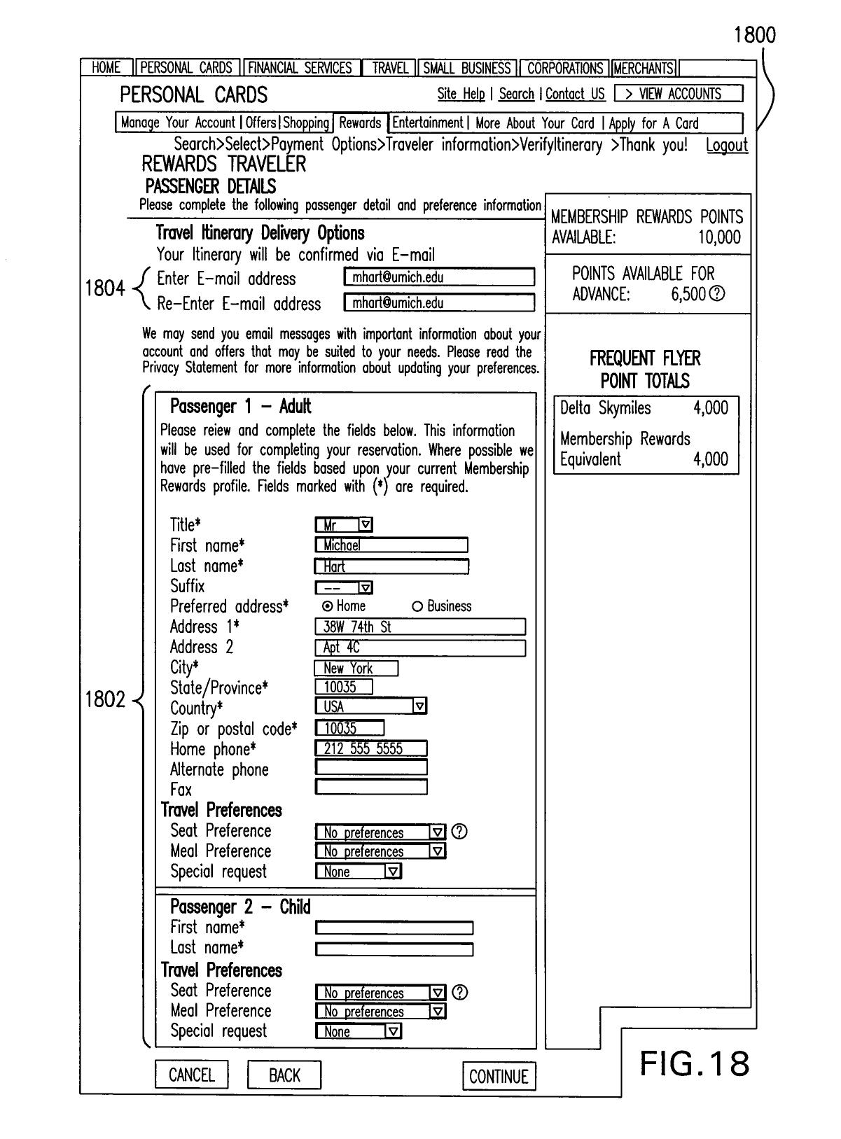

Returning to FIG. 3, once the point and cost totals have been calculated in step 340, method 300 proceeds to step 342. In step 342, any additional information needed to complete the travel booking is entered. For example, the names of the persons traveling may be entered in step 342. FIG. 18 is a screenshot of an example web page 1800 that may be displayed during step 342. Web page 1800 includes a traveler information entry section 1802 that allows the participant to enter contact and preference information for each person traveling. Web page 1800 may also include an itinerary delivery entry field 1804 that allows the participant to indicate where the itinerary should be delivered.

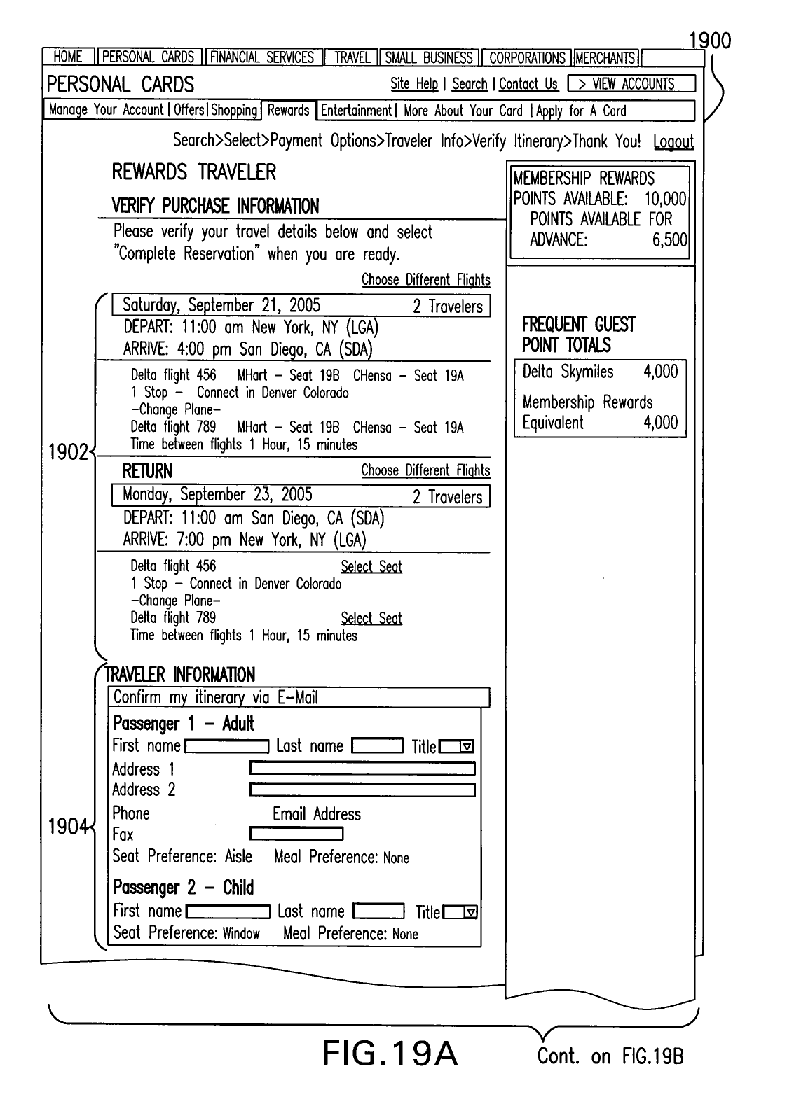

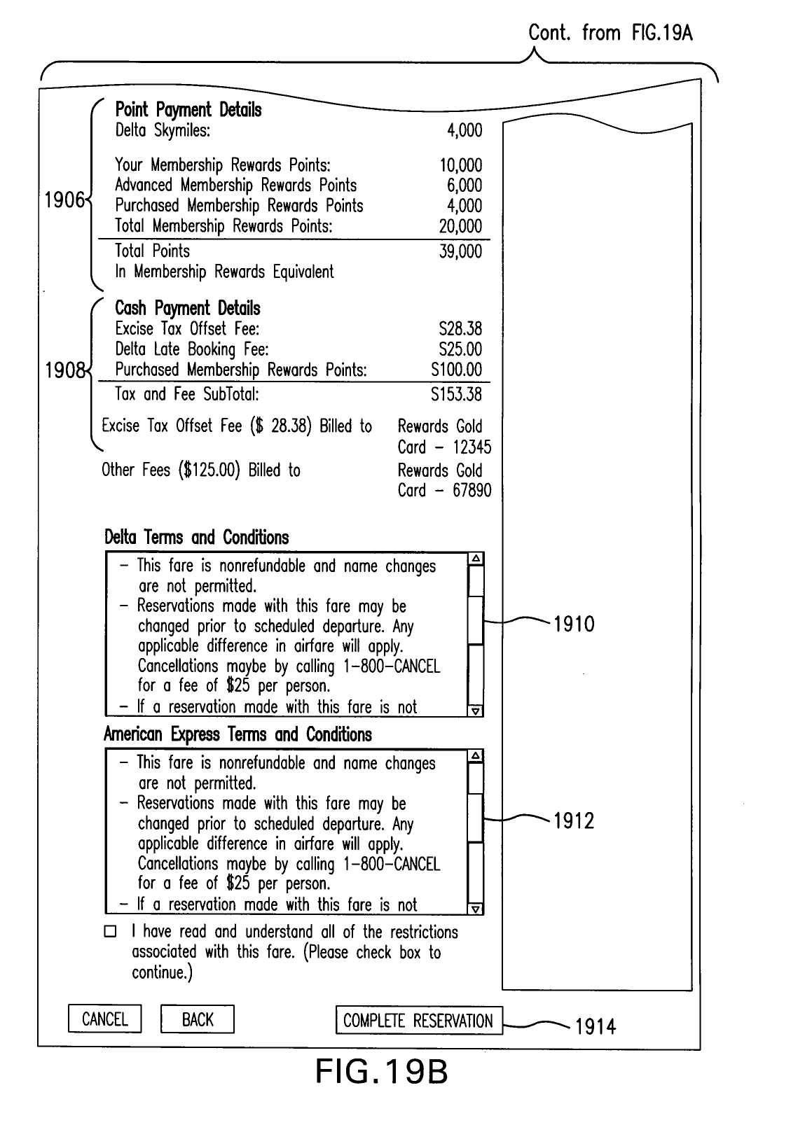

Once information has been entered in step 342, method 300 proceeds to step 344. In step 344, the participant verifies the booking and purchase information. All participant-entered data, as well as fee and tax amounts, are provided to the participant for verification. FIG. 19 is a screenshot of an example web page 1900 that may be displayed during step 344 when one or more airline tickets is being purchased. Web page 1900 includes an itinerary 1902, a traveler information summary 1904, a point payment summary 1906, and a cash payment summary 1908. Web page 1900 also includes a partner service provider terms and conditions text box 1910 and a comprehensive rewards program provider terms and conditions text box 1912. If the partner airline company allows the participant to select particular seats on the flight, method 300 optionally proceeds to step 346, in which the participant makes a flight seat selection. Once the participant has verified the information presented in step 344 and optionally made a seat selection in step 346, the participant completes the reservation and books with the partner service provider. This may be done, for example, by clicking a completion link 1914 on web page 1900.

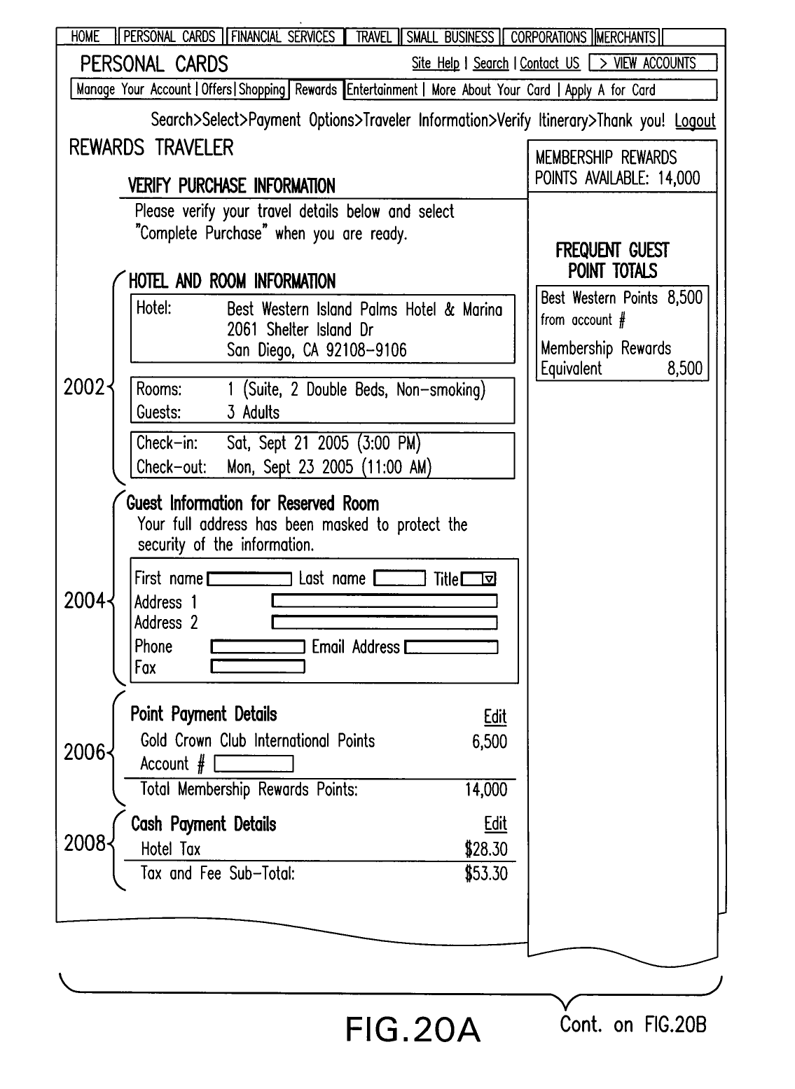

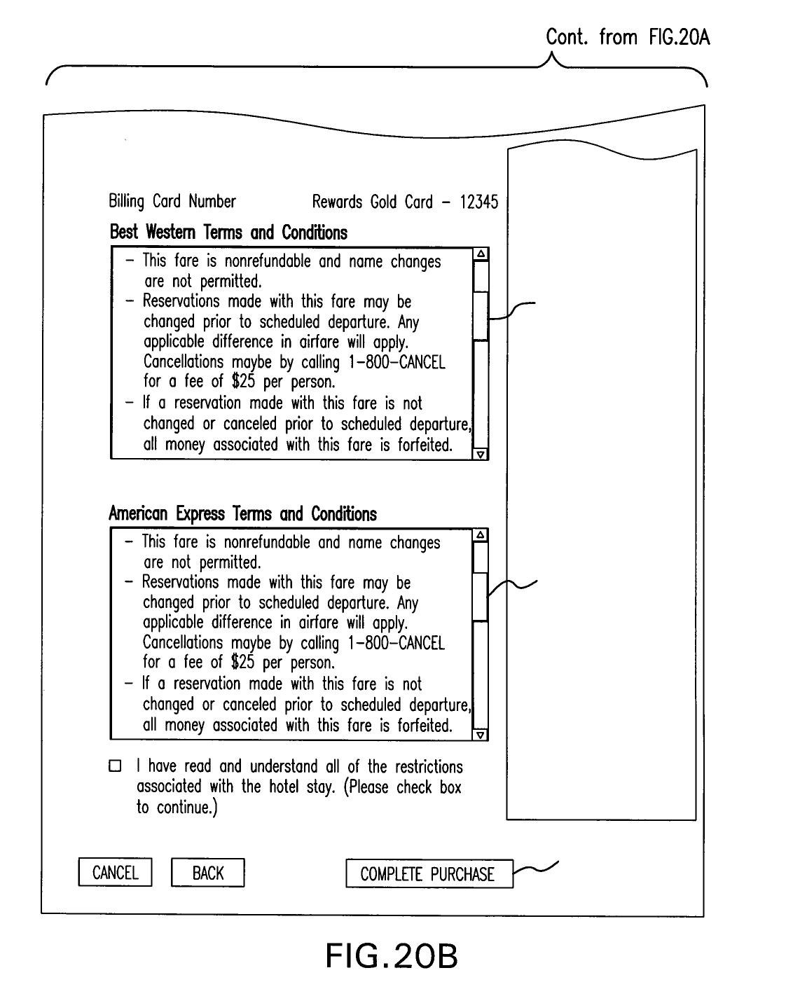

FIG. 20 is a screenshot of an example web page 2000 that may be displayed during step 344 when one or more hotel rooms is being purchased. Web page 2000 includes a hotel reservation summary 2002, a traveler information summary 2004, a point payment summary 2006, and a cash payment summary 2008. Web page 2000 also includes a partner service provider terms and conditions text box 2010 and a comprehensive rewards program provider terms and conditions text box 2012. Once the participant has verified the information presented in step 344, the participant completes the reservation and books with the partner service provider. This may be done, for example, by clicking a completion link 2014 on web page 2000.

Once the information has been verified by the participant in step 344, and the booking completed, method 300 proceeds to step 348. In step 348, a confirmation is provided to the participant that the reservation was successfully booked by the partner service provider. The participant is also notified of the updated number of rewards points in the participant's partner frequent customer program account and the number of rewards points in the participant's comprehensive rewards program account.

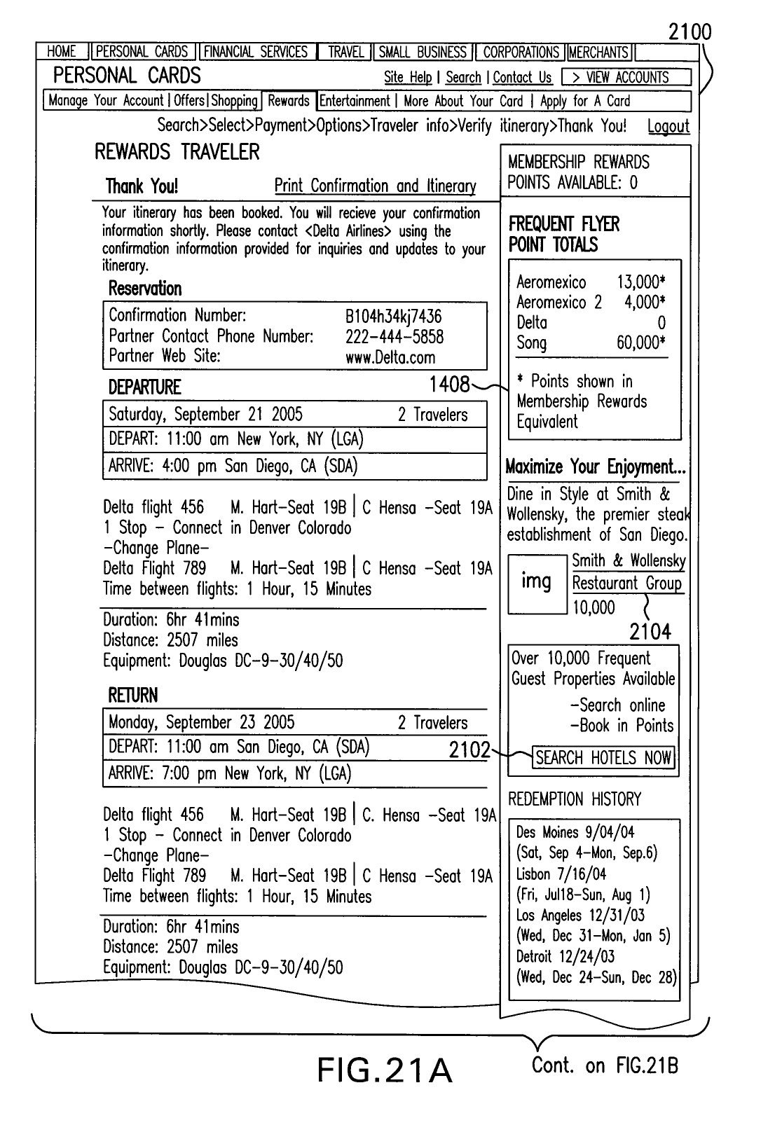

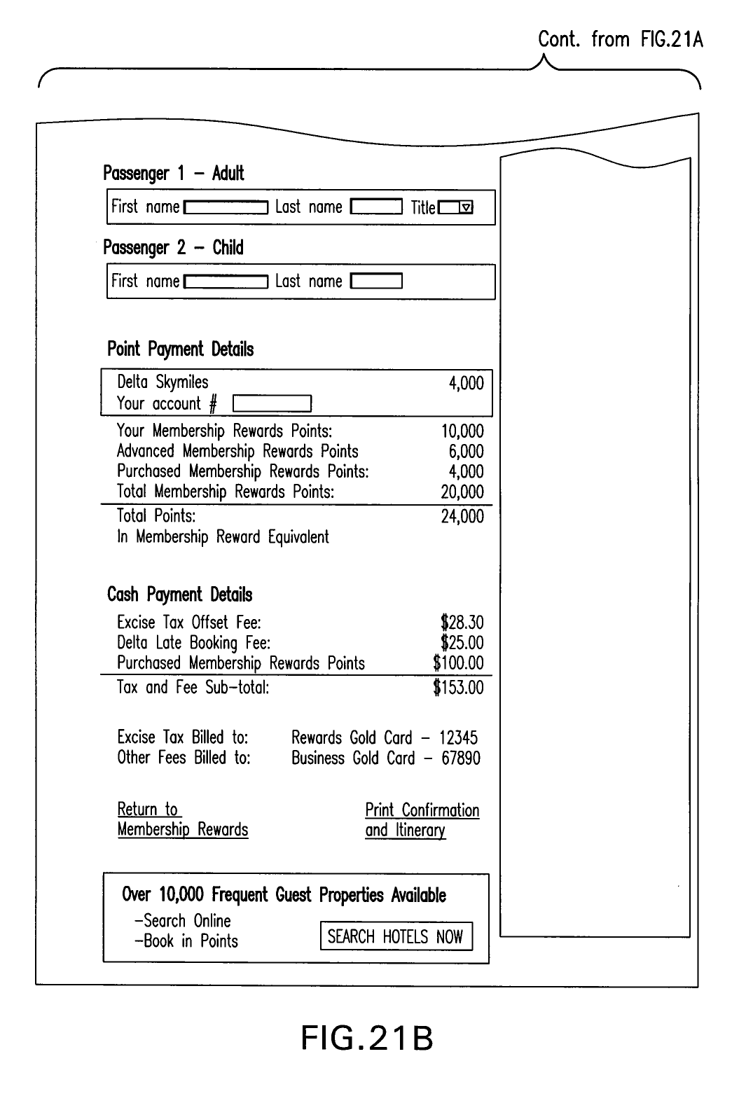

FIG. 21 is a screenshot of an example web page 2100 that may be used in step 348 to provide confirmation of an airline ticket purchase to the participant. Web page 2100 includes details about the booking made by the participant with the partner airline company. Web page 2100 also includes dashboard view 1408, which reflects the updated rewards point values available in the participant's accounts after the booking for all of their linked accounts. Web page 2100 may also include links to search hotels at the destination area (such as hotel search link 2102) and/or links to points of interest in the destination area (such as restaurant link 2104).

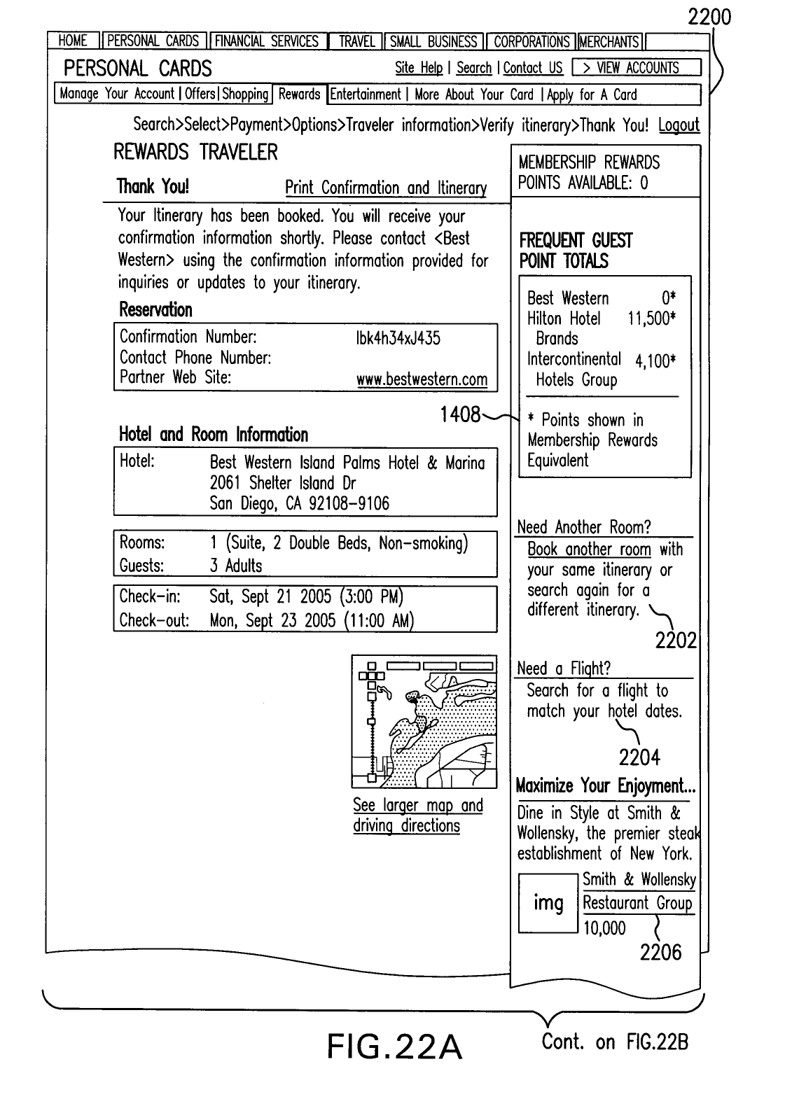

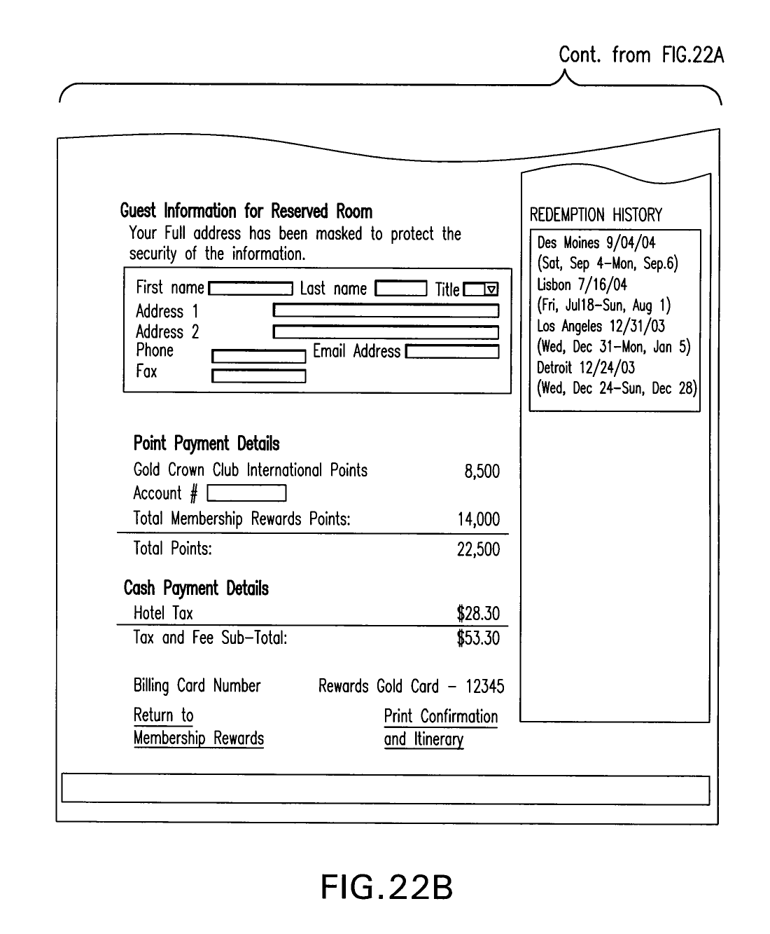

FIG. 22 is a screenshot of an example web page 2200 that may be used in step 348 to provide confirmation of a hotel room reservation to the participant. Web page 2200 includes details about the booking made by the participant with the partner hotel company. Web page 2200 also includes dashboard view 1408, which reflects the updated rewards point values available in the participant's accounts after the booking for all of their linked accounts. Web page 2200 may also include links to search for additional hotel rooms (such as hotel search link 2202, links to search for flights to the area surrounding the hotel (such as flight search link 2204), and links to points of interest near the hotel (such as restaurant link 2206).

The booked itinerary may be saved by the comprehensive rewards program provider and accessible to the participant any time the participant logs into the search, transfer, and booking tool or contacts the comprehensive rewards program provider.

III. Example Implementations

The present invention (i.e., system 100 and processes 200 and 300 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

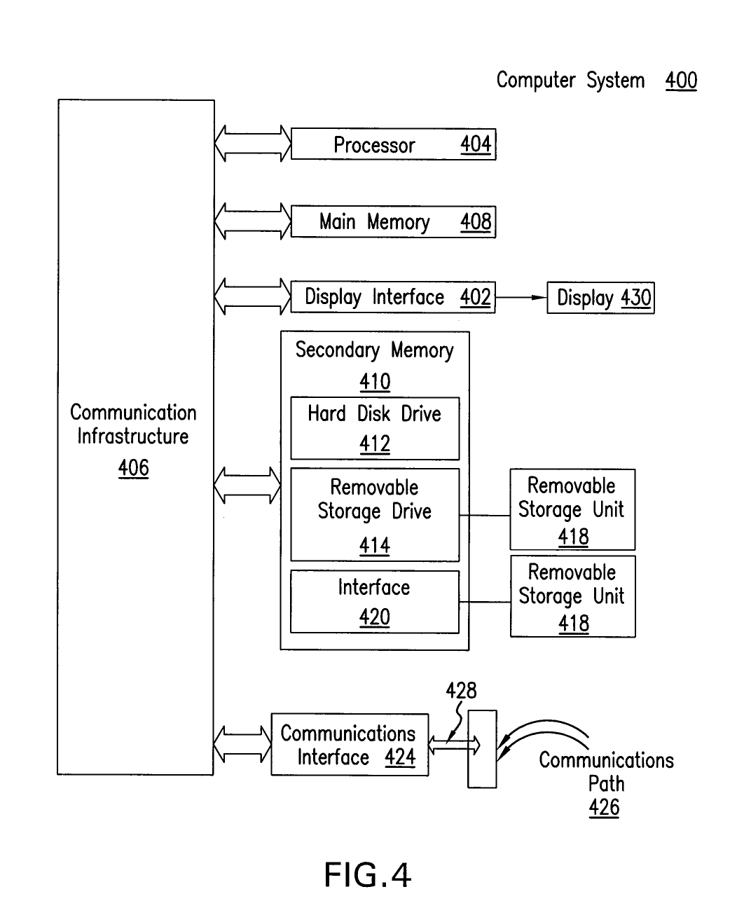

In fact, in one embodiment, the invention is directed toward one or more computer systems capable of carrying out the functionality described herein. An example of a computer system 400 is shown in FIG. 4.

The computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 418 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 418 and interfaces 420, which allow software and data to be transferred from the removable storage unit 418 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the present invention. Accordingly, such computer programs represent controllers of the computer system 400.

In an embodiment where the invention is implemented using software, the software may be stored in a computer program product and loaded into computer system 400 using removable storage drive 414, hard drive 412 or communications interface 424. The control logic (software), when executed by the processor 404, causes the processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of searching, transferring, and booking reward travel for a participant, comprising:
linking a frequent customer program account associated with the participant to a comprehensive rewards program account;
requesting travel options customized for the participant from a partner service provider associated with the frequent customer program account, wherein the travel options are customized based on a status of the customer with the frequent customer program;
providing the customized travel options to the participant with frequent customer program point indications for each option;
receiving a selection for a specific travel option from the participant; and
sending a request to the partner service provider to redeem reward points and book the specific travel option.

2. The method of claim 1, wherein the requesting step comprises:
requesting customized travel options from a partner service provider associated with the linked frequent customer program account; and
requesting non-customized travel options from a partner service provider not associated with the linked customer program account.

3. The method of claim 2, wherein the providing step comprises:
providing the customized travel options with frequent customer program point indications for each option from the partner service provider associated with the linked frequent customer program account; and
providing the non-customized travel options without point indications from the partner service provider not associated with the linked frequent customer program account.

4. The method of claim 1, wherein the sending step comprises:
sending a request to redeem reward points associated with the linked frequent customer program.

5. The method of claim 1, wherein the sending step comprises:
sending a request to redeem reward points associated with the comprehensive rewards program.

6. The method of claim 1, wherein the linking step comprises:
linking multiple frequent customer program accounts associated with the participant, wherein each frequent customer program account is associated with a partner service provider that is different than partner service providers associated with other frequent customer program accounts.

7. The method of claim 1, further comprising:
receiving from the participant at least one travel preference,
wherein the requesting step includes requesting customized travel options based on the travel preference.

8. The method of claim 1, further comprising transferring points as needed from the comprehensive rewards program account to the partner service provider.

9. A system for searching, transferring, and booking reward travel for a participant, comprising:
a processor; and
a memory in communication with the processor, the memory for storing a plurality of processing instructions for directing the processor to:
link a frequent customer program account associated with the participant to a comprehensive rewards program account;
request travel options customized for the participant from a partner service provider associated with the frequent customer program account, wherein the travel options are customized based on a status of the customer with the frequent customer program;
provide the customized travel options to the participant with frequent customer program point indications for each option;
receive a selection for a specific travel option from the participant; and
send a request to the partner service provider to redeem reward points for the specific travel option.

10. The system of claim 9, wherein the instructions for directing the processor to request travel options comprise instructions for directing the processor to:
request customized travel options from a partner service provider associated with the linked frequent customer program account; and
request non-customized travel options from a partner service provider not associated with the linked customer program account.

11. The system of claim 10, wherein the instructions for directing the processor to provide the customized travel options to the participant comprise instructions for directing the processor to:
provide the customized travel options with frequent customer program point indications for each option from the partner service provider associated with the linked frequent customer program account; and
provide the non-customized travel options without point indications from the partner service provider not associated with the linked frequent customer program account.

12. The system of claim 9, wherein the instructions for directing the processor to send a request comprise instructions for directing the processor to:
send a request to redeem reward points associated with the linked frequent customer program.

13. The system of claim 9, wherein the instructions for directing the processor to send a request comprise instructions for directing the processor to:
send a request to redeem reward points associated with the comprehensive rewards program.

14. The system of claim 9, wherein the instructions for directing the processor to link a frequent customer account comprise instructions for directing the processor to:
link multiple frequent customer program accounts associated with the participant, wherein each frequent customer program account is associated with a partner service provider that is different than partner service providers associated with other frequent customer program accounts.

15. The system of claim 9, wherein the plurality of processing instructions further comprise instructions for directing the processor to transfer points as needed from the comprehensive rewards program account to the partner service provider.

16. A computer program product comprising a computer usable medium having control logic stored therein for causing a computer to search, transfer, and book reward travel, said control logic comprising:
first computer readable program code means for causing the computer to link a frequent customer program account associated with the participant to a comprehensive rewards program account;
second computer readable program code means for causing the computer to request travel options customized for the participant from a partner service provider associated with the frequent customer program account, wherein the travel options are customized based on a status of the customer with the frequent customer program;
third computer readable program code means for causing the computer to provide the customized travel options to the participant with frequent customer program point indications for each option;
fourth computer readable program code means for causing the computer to receive a selection for a specific travel option from the participant; and
fifth computer readable program code means for causing the computer to send a request to the partner service provider to redeem reward points for the specific travel option.

17. The computer program product of claim 16, wherein the second computer readable program code means comprises:
sixth computer readable program code means for causing the computer to request customized travel options from a partner service provider associated with the linked frequent customer program account; and
seventh computer readable program code means for causing the computer to request non-customized travel options from a partner service provider not associated with the linked customer program account.

18. The computer program product of claim 17, wherein the third computer readable program code means comprises:
eighth computer readable program code means for causing the computer to provide the customized travel options with frequent customer program point indications for each option from the partner service provider associated with the linked frequent customer program account; and
ninth computer readable program code means for causing the computer to provide the non-customized travel options without point indications from the partner service provider not associated with the linked frequent customer program account.

19. The computer program product of claim 16, wherein the fifth computer readable program code means comprises:
sixth computer readable program code means for causing the computer to send a request to redeem reward points associated with the linked frequent customer program.

20. The computer program product of claim 16, wherein the fifth computer readable program code means comprises:
sixth computer readable program code means for causing the computer to send a request to redeem reward points associated with the comprehensive rewards program.

21. The computer program product of claim 16, wherein the first computer readable program code means comprises:
sixth computer readable program code means for causing the computer to link multiple frequent customer program accounts associated with the participant, wherein each frequent customer program account is associated with a partner service provider that is different than partner service providers associated with other frequent customer program accounts.

22. The computer program product of claim 16, wherein the control logic further comprises sixth computer readable program code means for causing the computer to transfer points as needed from the comprehensive rewards program account to the partner service provider.
